(19) United States
(12) Patent Application Publication
(10) Pub. No.: US 2025/0019482 A1
(43) Pub. Date: Jan. 16, 2025

(54) SYNTHESIS AND FABRICATION OF MECHANICALLY ROBUST AND MESOPOROUS ABAC TETRABLOCK POLYMER MEMBRANES FOR ULTRAFILTRATION

(71) Applicant: BOARD OF REGENTS, THE UNIVERSITY OF TEXAS SYSTEM, Austin, TX (US)

(72) Inventors: Benny Freeman, Austin, TX (US); Noah Wamble, Austin, TX (US); Joan F. Brennecke, Austin, TX (US); Ben Pedretti, Austin, TX (US); Nate Lynd, Austin, TX (US); Adam Mann, Austin, TX (US); Gabriel Sanoja, Austin, TX (US)

(21) Appl. No.: 18/766,484

(22) Filed: Jul. 8, 2024

Related U.S. Application Data
(60) Provisional application No. 63/525,489, filed on Jul. 7, 2023.

(51) Int. Cl. C08F 297/02; B01D 53/22; B01D 61/14; B01D 67/00; B01D 69/02; B01D 71/26; B01D 71/28; B01D 71/52; B01D 71/80; C08F 297/04

(52) U.S. Cl. CPC C08F 297/02; B01D 53/228; B01D 61/145; B01D 67/0013; B01D 69/02; B01D 71/26; B01D 71/261; B01D 71/262; B01D 71/281; B01D 71/283; B01D 71/5211; B01D 71/80; C08F 297/04; B01D 2325/02833

(57) ABSTRACT

Disclosed is a tetrablock polymer including the formula ABAC, wherein A, B and C are each blocks of the polymer, where A is a glassy block; B is a rubbery block; and C is a hydrophilic block. Also, a membrane including any of the disclosed polymers organized to define pores with an average pore diameter of about 15 nm to about 50 nm is disclosed. A supported ionic liquid membrane including any of the disclosed membranes and an ionic liquid within the pores are also disclosed. Methods of forming a membrane and methods of purifying a liquid or gas are disclosed.

### CROSS REFERENCE TO RELATED APPLICATIONS

This application claims the benefit of priority to U.S. Provisional Application No. 63/525,489, filed Jul. 7, 2023, which is incorporated by reference herein in its entirety.

### GOVERNMENT SUPPORT CLAUSE

This invention was made with government support under Grant No. DE-SC0019272 awarded by the Department of Energy. The Government has certain rights in the invention.

### BACKGROUND

As the effects of climate change and the demands of a growing population continue to strain conventional resource production methods, there is an increasing need for advanced materials and technologies that enable low-cost, low-energy separations and manufacturing (Elimelech, M. et al. The Future of Seawater Desalination: Energy, Technology, and the Environment. Science 2011, 333 (6043), 712-717; Madhura, L. et al. Membrane Technology for Water Purification. Environ. Chem. Lett. 2018, 16 (2), 343-365; Water for a Sustainable World; Unesco, Ed.; The United Nations world water development report; UNESCO: Paris, 2015; Healy, R. W. et al. The Water-Energy Nexus—An Earth Science Perspective; Circular; Circular 1407; U.S.G.S., 2015). In recent decades, block copolymers have emerged as examples of such materials, finding use in lithography (Feng, H. et al. Optimized Design of Block Copolymers with Covarying Properties for Nanolithography. Nat. Mater. 2022, 21 (12), 1426-1433; Kwak, J. et al. Fabrication of Sub-3 Nm Feature Size Based on Block Copolymer Self-Assembly for Next-Generation Nanolithography. Macromolecules 2017, 50 (17), 6813-6818; Kubo, T. et al. Spontaneous Alignment of Self-Assembled ABC Triblock Terpolymers for Large-Area Nanolithography. Appl. Phys. Lett. 2008, 93 (13), 133112), manufacturing (Gates, B. D. et al. New Approaches to Nanofabrication: Molding, Printing, and Other Techniques. Chem. Rev. 2005, 105 (4), 1171-1196; Cummins, C. et al. Enabling Future Nanomanufacturing through Block Copolymer Self-Assembly: A Review. Nano Today 2020, 35, 100936; Hu, X.-H. et al. Fabrication of Nanodevices Through Block Copolymer Self-Assembly. Front. Nanotechnol. 2022, 4, 762996), and membrane-based separations like ultrafiltration (UF) (Moon, J. D. et al. Can Self-Assembly Address the Permeability/Selectivity Trade-Offs in Polymer Membranes? Macromolecules 2020, 53 (14), 5649-5654; Karunakaran, M. et al. Isoporous PS-b-PEO Ultrafiltration Membranes via Self-Assembly and Water-Induced Phase Separation. J. Membr. Sci. 2014, 453, 471-477; Nunes, S. P. et al. Ultraporous Films with Uniform Nanochannels by Block Copolymer Micelles Assembly. Macromolecules 2010, 43 (19), 8079-8085; Peinemann, K.-V. et al. Asymmetric Superstructure Formed in a Block Copolymer via Phase Separation. Nat. Mater. 2007, 6 (12), 992-996; Yang, S. Y. et al. Nanoporous Membranes with Ultrahigh Selectivity and Flux for the Filtration of Viruses. Adv. Mater. 2006, 18 (6), 709-712).

Conventional UF membranes, utilized in water purification and food production, are typically manufactured using a process known as non-solvent-induced phase separation (NIPS) (Baker, R. W. Membrane Technology and Applications, 3rd ed.; John Wiley and Sons Ltd, 2012). In this process, a homopolymer solution (or dope) is blade coated onto a substrate and immersed into a nonsolvent like water. Solvent-nonsolvent interdiffusion, phase separation, and kinetic arrest (i.e., vitrification) lead to membranes with asymmetric structures (Müller, M. et al. Nonequilibrium Processes in Polymer Membrane Formation: Theory and Experiment. Chem. Rev. 2021, 121 (22), 14189-14231) including a thin selective layer (≤100 nm) positioned atop a porous substructure of (i) negligible resistance to hydrodynamic flow and (ii) sufficient ability to bear mechanical loads (Werber, J. R. et al. Materials for Next-Generation Desalination and Water Purification Membranes. Nat. Rev. Mater. 2016, 1 (5), 16018; van de Witte, P. et al. Phase Separation Processes in Polymer Solutions in Relation to Membrane Formation. J. Membr. Sci. 1996, 117 (1-2), 1-31; Guillen, G. R. et al. Preparation and Characterization of Membranes Formed by Nonsolvent Induced Phase Separation: A Review. Ind. Eng. Chem. Res. 2011, 50 (7), 3798-3817; Hampu, N. et al. Next-Generation Ultrafiltration Membranes Enabled by Block Polymers. ACS Nano 2020, 14 (12), 16446-16471; Mehta, A. et al. Permeability and Selectivity Analysis for Ultrafiltration Membranes. J. Membr. Sci. 2005, 249 (1-2), 245-249). However, these homopolymer-based membranes have a broad distribution of surface pores and, as a result, limited selectivity and rejection.

To address this problem, UF membranes can be manufactured by track-etching. This process leads to membranes with a low density of narrowly dispersed surface pores, which are usually more selective but less permeable than membranes manufactured by NIPS. To separate solutes of more similar size, a molecular rationale is needed to design and manufacture UF membranes with both narrowly dispersed surface pores and negligible resistance to hydrodynamic flow.

Thus, there exists a need for improved polymers for ultrafiltration and membranes made therefrom. These needs and others are at least partially satisfied by the present disclosure.

### SUMMARY

In an aspect, provided is a tetrablock polymer including the formula ABAC, wherein A, B and C are each blocks of the polymer, where A is a glassy block; B is a rubbery block; and C is a hydrophilic block.

In another aspect, provided is a membrane, including: any of the disclosed polymers organized to define pores with an average pore diameter of about 15 nm to about 50 nm.

In yet another aspect, provided is a supported ionic liquid membrane, including: any of the disclosed membranes and an ionic liquid within the pores.

In yet still another aspect, provided is method of forming a membrane, including: a. casting a solution including any of the disclosed polymers, a solvent for the polymer, and a salt onto a substrate; b. drying the cast solution, and c. contacting the dried, cast solution with a nonsolvent.

In yet still another aspect, provided is a method of purifying a liquid or gas, including: contacting any of the disclosed membranes with the liquid or gas.

Other systems, methods, features and/or advantages will be or may become apparent to one with skill in the art upon examination of the following drawings and detailed description. It is intended that all such additional systems, methods, features and/or advantages be included within this description and be protected by the accompanying claims.

### BRIEF DESCRIPTION OF DRAWINGS

The accompanying figures, which are incorporated in and constitute a part of this specification, illustrate several aspects and together with the description serve to explain the principles of the invention.

FIG. 1A shows mechanical testing data where SV (polystyrene-b-poly(4-vinylpyridine) is the polymer used to make isoporous membranes. SISV has similar mechanical properties to polysulfone (PSf). FIG. 1B shows pore size distribution of SISV membrane at the surface, which reveals an average pore size of 18 nm and a standard deviation of 2 nm. FIG. 1C shows a scanning electron micrograph of the top surface of an SISV membrane which has high pore density. The casting conditions are given on the micrograph. The SISV polymer had a total molecular weight of 66 kg/mol, and a weight fraction of the poly(4-vinylpyridine) block of 18 wt %. The solution was 12 wt % of this polymer dissolved in a 70/30 w/w solution of 1,4-dioxane/tetrahydrofuran which had 0.15 wt % copper bis(trifluoromethylsulfonyl)imide dissolved in it. This dope was cast at 200 μm thick and allowed to evaporate for 30 seconds before immersing it in the water bath.

FIGS. 2A-2D depict dense film TGA data for SESO-122 kDa (FIG. 2A), SESO-82 kDa (FIG. 2B), SV (FIG. 2C), and V (FIG. 2D). Each inset plot shows the mass loss up to 200° C. ranges from 1%-3.5% for all samples, suggesting that little residual solvent remains in the dense films.

FIG. 3 depicts TGA data on asymmetric SESO membrane cast from 22 wt % SESO-122kDA in 75/25 w/w DOX/THF with a 5 s dry step time reveals that minimal solvent remains in the asymmetric membranes. Inset plot reveals that up to 200° C. there is less than 1% mass loss, suggesting little to no residual solvent in the membrane.

FIG. 4 is a captive bubble contact angle image of membrane cast from 22 wt % SESO-122 kDa in 75/25 w/w DOX/THF with a 5 s dry step evaporation time. The captive bubble contact angle for the SESO isoporous membrane was 50°.

FIG. 5 depicts Dynamic Mechanical Analysis (DMA) results for 160 kDa poly(4-vinylpyridine) showing the rubbery plateau of the stress relaxation modulus, highlighted by the dotted line. The data is plotted on a log-log scale.

FIGS. 6A-6C depict castings done right under the optimal ordering onto a lattice seen in the SAXS data in FIG. 10B at 17 wt % polymer concentration and in FIG. 10C at 13 wt % polymer concentration. In the 50/50 w/w DOX/THE blend, these castings were done at a lower concentration of 16 wt % polymer concentration at both a 5 s (FIG. 6A) and a 20 s (FIG. 6B) dry step to attempt to place the surface layer concentration after the dry step at the ordered state seen in FIG. 10B at 17 wt % polymer such that this solution order could be realized on the membrane surface after the NIPS step. The same procedure was followed for the 75/25 w/w solvent blend by casting at 11 wt % polymer with a 20 s dry step time (FIG. 6C) to try to reach the ordered solution SAXS seen at 13 wt % polymer on the surface layer after the dry step time.

FIG. 7 depicts the influence of dry step evaporation time (5-60 s) on the skin layer morphology of SNIPS membranes prepared from 22 wt % SESO-122 kDa in 75/25 w/w DOX/THF. All membranes were cast at 50%±5% relative humidity. All scale bars are 500 nm.

FIGS. 8A-8B depict the influence of polymer concentration and dry step time on membrane surface structure for 122 kDa SESO membrane cast from a 50/50 w/w DOX/THF solvent blend. FIG. 8C depicts the influence of polymer concentration in 75/25 w/w DOX/THF solvent blend on the membrane surface structure for 122 kDa SESO membrane. All membranes were cast with a 5 s evaporation step at 50%+5% relative humidity. All scale bars are 500 nm.

FIG. 9A depicts the synthesis of SES-OH and chain extension with ethylene oxide to afford the tetrablock polymer SESO. FIG. 9B depicts the difference in chain elongation under tension between triblock and tetrablock polymers. Chemically linking the glassy polymer blocks with a rubbery block inhibits chain pullout and material fracture. FIG. 9C depicts that SEC traces of SIS-OH and final SESO show a clear shift in molecular weight (i.e., retention time) after chain extension. FIG. 9D is a photograph of an asymmetric SESO membrane bent at a 180° angle.

FIGS. 10A-10C depict SAXS data of SESO casting solutions: 82 kDa in 50/50 w/w DOX/THF (FIG. 10A), 122 kDa in 75/25 w/w DOX/THF (FIG. 10B), and 122 kDa in 75/25 w/w DOX/THF (FIG. 10C). The weight percent of the polymer is labeled on each spectrum. Labeled peaks correspond to the peak positions q/q*=1, √2, √3 and are consistent with a BCC lattice (Förster, S. et al. Scattering Curves of Ordered Mesoscopic Materials. J. Phys. Chem. B 2005, 109 (4), 1347-1360).

FIG. 11A is an SEM micrograph for an isoporous SV membrane cast from 13 wt % SV in 33/33/33 w/w/w DOX/DMF/THF with a 20 s dry step time. FIG. 11B is an SEM micrograph of the SESO-122 kDa membrane cast from 22 wt % polymer in 75/25 w/w DOX/THF with a 5 s dry step time. FIG. 11C depicts surface pore size distributions for the SESO and SV membranes. The SV pore size distribution had an average pore diameter, μ, of 56±10 nm. The average SESO pore diameter was 24±4 nm. These average and standard deviation values came from image analysis of three SEMs of each sample. Both scale bars are 500 nm. Pore size distributions were created from binarized images, and an example is shown in FIGS. 14A-14C. The bottom surface of the SESO-122 kDa membrane is shown in FIG. 15. Solution SAXS for the SV polymer in 33/33/33 w/w/w DOX/DMF/THF is shown in FIG. 16.

FIGS. 12A-12B depict Fast Fourier transforms (FFT) of SEM micrographs in FIGS. 11A-11C for 13 wt % SV cast from DOX/DMF/THF with a 20 s dry step time (FIG. 12A) and 22 wt % SESO-122 kDa in 75/25 w/w DOX/THF with a 5 s dry step time (FIG. 12B) reveal that long range ordering is present in the SV sample due to the appearance of a hexagonal pattern in the FFT, which is not seen in the FFT on the SESO-122 kDa sample. FFT was performed using ImageJ Analysis on SEMs.

FIG. 13 depicts SEM and pore size distribution of ISV polymer reported by Phillip et al. [11]. Scale bar is 200 nm. The SEM image is adapted with permission from Phillip et al. Copyright 2011 American Chemical Society.

FIG. 14A is an SEM micrograph of 50 nm track-etched membrane. FIG. 14B shows a binarized mask of 50 nm track etched SEM micrograph used to estimate pore size distribution. FIG. 14C depicts pore size distribution calculated for the track etched membrane with a 50 nm pore size from the binary mask in FIG. 14B that came from SEM micrograph in FIG. 14A. This track-etched membrane had an average pore size of 54±14 nm. To create the binarized image, MATLAB code was used adapted from code used to measure the macroporosity written by Bridge, et al. (Bridge, A. T. et al. Rapid Macrovoid Characterization in Membranes Prepared via Nonsolvent-Induced Phase Separation: A Comparison between 2D and 3D Techniques. J. Membr. Sci. 2022, 661, 120923).

FIG. 15 depicts top surface, cross section, and bottom surface SEM images of 22 wt % SESO-122 kDa membrane cast from 75/25 w/w DOX/THF with a 5 s dry step evaporation time at 50±5% RH.

FIG. 16 depicts SAXS data of the commercial SV polymer in 33/33/33 w/w/w DOX/DMF/THF at 10 wt %, 12 wt %, and 16 wt % polymer concentrations.

FIGS. 17A-17B depict cross-sections of SESO-122 kDa membrane cast from 22 wt % polymer in 75/25 w/w DOX/THF with a 5 s dry step time (FIG. 17A) compared to an SV membrane cast from 13 wt % polymer in 33/33/33 w/w/w DOX/DMF/THF with a 20 s dry step time (FIG. 17B). FIGS. 17C-17D depict binarized images of the SESO-122 kDa (FIG. 17C) and SV (FIG. 17D) membranes used for calculating the substructure macroporosity, Dₘ.

FIG. 18 depicts representative stress-stretch curves of the SESO-122 kDa and the SV dense films reveal drastic differences at large strains. The inset illustrates the mechanical properties at low strains. The curves are labeled as follows: SESO-122 kDa and SV.

FIGS. 19A-19B depict representative stress-stretch curves of SESO and SV dense films (FIG. 19A) and zoomed-in dense films (FIG. 19B). Curves are directly labeled as follows: SESO-122 kDa, SESO-82 kDa and SV.

FIG. 20A depicts representative stress-stretch curves of SESO-122 kDa and SV membranes. FIG. 20B depicts representative stress-stretch curves of SESO-122 kDa and SV membranes normalized by the macroporosity, Dₘ.

FIG. 21A depicts pure water permeance data for a SESO membrane cast from 22 wt % SESO-122 kDa in 75/25 DOX/THF with a 5 s dry step time is compared to that of a 50 nm track-etched membrane. The line of best fit was constrained to pass through the origin. Each transmembrane pressure point is the average of triplicate measurements, and the error bars represent ±1 standard deviation. Membranes prepared from SV were too fragile for testing at these pressures. FIG. 21B depicts pore density (grey) and surface porosity (black) characteristics for isoporous tetrablock and diblock polymer membranes outperform track-etched membranes. Each value is the average of triplicate measurements, and the error bars represent ±1 standard deviation. These values were obtained using a MATLAB code that was adapted from Bridge et al. (Bridge, A. T. et al. Rapid Macrovoid Characterization in Membranes Prepared via Nonsolvent-Induced Phase Separation: A Comparison between 2D and 3D Techniques. J. Membr. Sci. 2022, 661, 120923).

FIGS. 22A-22B depict cross-sections of SESO-122 kDa membrane cast from 22 wt % polymer in 75/25 w/w DOX/THF with a 5 s dry step time (FIG. 22A) compared to an SV membrane cast from 13 wt % polymer in 33/33/33 w/w/w DOX/DMF/THF with a 20 s dry step time (FIG. 22B). The transition between the skin layer and substructure is denoted on the figure. The skin layer thickness is assumed to be approximately 100 nm for Hagen-Poiseuille calculations based on these SEM images (dotted line).

FIG. 23A depicts polymerization reaction conditions. The first three blocks synthesize for 24 h each. After the final polystyrene block, 10 eq of 1,1-diphenylethylene are added, causing the reaction to change color from bright orange to a deep red. After 1 hour, ca. 80% of the cyclohexane solvent is removed via distillation under reduced pressure. The semi-solid, red polymer is then re-dissolved in THF, cooled to −78° C., and the final block is added over the course of 3-4 h. FIG. 23B is a schematic of how micelles form in solution which leads to an isoporous membrane.

FIG. 24 depicts the influence of additives on the top surface membrane morphology which shows that adding copper increases the dry step window that can be used to cast an isoporous membrane and shows that the order is better.

FIG. 25 depicts solution SAXS of SISV in 70/30 DOX/THF revealing that the system begins with limited ordering.

FIGS. 26A-26B depict in situ grazing incidence SAXS (GISAXS) data collected from 0 s to 60 s for a system without an additive (FIG. 26A) and with 0.15 wt % copper acetate (FIG. 26B). This data shows that increasing the dry step time leads to better ordering and that ordering is much better with the copper acetate present due to the presence of a stronger primary peak and the appearance of a secondary peak that is not present without the additive.

FIG. 27 depicts tensile testing of asymmetric films of SV and SISV. SV was cast from a 13 wt % polymer solution in a 1:1:1 DOX/DMF/THF solution, and SISV was cast from a 12 wt % polymer solution in 70:30 DOX/THE solution with 0.15 wt % copper acetate

FIG. 28A depicts pH responsive membrane rejection for a 12% SISV membrane cast from 70/30 DOX/THF with 0.15 wt % copper bistriflimide. FIG. 28B depicts permeance of isoporous membrane as a function of pH. FIG. 28C depicts calculated and fitted pore size distribution diameters as a function of pH.

FIG. 29 depicts blowout curves of an [hmim][Tf₂N]/PES-30 made with a commercially available support with a nominal pore size of 30 nm compared to [hmim][Tf₂N]/SISV support. The PES-30 support is stable up to 3 bar, while the isoporous SISV support is stable up to 11 bar transmembrane pressure.

### DETAILED DESCRIPTION

The materials, compounds, compositions, and methods described herein may be understood more readily by reference to the following detailed description of specific aspects of the disclosed subject matter and the Examples and Figures included therein.

Before the present materials, compounds, compositions, and methods are disclosed and described, it is to be understood that the aspects described below are not limited to specific synthetic methods or specific reagents, which may, of course, vary. It is also to be understood that the terminology used herein describes particular aspects only and is not intended to be limiting.

Also, throughout this specification, various publications are referenced. The disclosures of these publications in their entireties are hereby incorporated by reference into this application to more fully describe the state of the art to which the disclosed matter pertains. The references disclosed are also individually and expressly incorporated by reference herein for the material contained in them that is discussed in the sentence in which the reference is relied upon.

### Definitions

In this specification and in the claims that follow, reference will be made to a number of terms, which shall be defined to have the following meanings:

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a compound”, “a composition”, or “a cancer”, includes, but is not limited to, two or more such compounds, compositions, or cancers, and the like.

It should be noted that ratios, concentrations, amounts, and other numerical data can be expressed herein in a range format. It can be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it can be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

### Compositions

Block copolymers self-assemble in solution, templating the structure of UF membranes before NIPS (Peinemann, K.-V. et al. Asymmetric Superstructure Formed in a Block Copolymer via Phase Separation. Nat. Mater. 2007, 6 (12), 992-996; Hampu, N. et al. Next-Generation Ultrafiltration Membranes Enabled by Block Polymers. ACS Nano 2020, 14 (12), 16446-16471; Grzetic, D. J. et al. Modeling Microstructure Formation in Block Copolymer Membranes Using Dynamical Self-Consistent Field Theory. ACS Macro Lett. 2023, 12 (1), 8-13). This process, known as SNIPS (Id.; Radjabian, M. et al. Influence of Solvent on the Structure of an Amphiphilic Block Copolymer in Solution and in Formation of an Integral Asymmetric Membrane. ACS Appl. Mater. Interfaces 2017, 9 (37), 31224-31234), is potentially suitable for large-scale manufacturing and yields membranes with narrower distributions of surface pores relative to conventional NIPS membranes (Radjabian, M. et al. Advanced Porous Polymer Membranes from Self-Assembling Block Copolymers. Prog. Polym. Sci. 2020, 102, 101219). However, a major problem with membranes manufactured up to this point by SNIPS is that while they have the potential to be both selective and permeable, they are typically very brittle. For example, poly(styrene-b-(4-vinylpyridine)) (SV), the most widely used block copolymer in SNIPS, readily breaks when subjected to a mechanical load.

This work provides a molecular rationale for co-designing the mechanical and permeation properties of block copolymer membranes by revisiting the structure-property relationships of polymer glasses. The mechanical properties of these materials are intimately related to the packing length, p, of the polymer chains (Fetters, L. J. et al. Connection between Polymer Molecular Weight, Density, Chain Dimensions, and Melt Viscoelastic Properties. Macromolecules 1994, 27 (17), 4639-4647), as this parameter governs the entanglement density and the energy dissipation mechanisms (i.e., crazing and shear yielding) acting within the polymer at large strains. Low packing lengths lead to high entanglement densities, shear yielding, and good mechanical properties, whereas high packing lengths result in low entanglement densities, crazing, and brittle-like fracture (Fetters, L. J. et al. Packing Length Influence in Linear Polymer Melts on the Entanglement, Critical, and Reptation Molecular Weights. Macromolecules 1999, 32 (20), 6847-6851), For instance, polymers used in conventional UF membranes, such as polysulfone, typically have a packing length of p≈0.2 nm, an entanglement molecular weight of Mₑ≈1.98 kDa, and are ductile (Id.; Donald, A. M. et al. Craze Initiation and Growth in High-Impact Polystyrene. J. Appl. Polym. Sci. 1982, 27 (10), 3729-3741; Kramer, E. J. Craze Fibril Formation and Breakdown. Polym. Eng. Sci. 1984, 24 (10), 761-769). In contrast, polymers used as structural blocks in isoporous membranes, such as polystyrene, have a packing length of p≈0.4 nm, an entanglement molecular weight of Mₑ≈13.3 kDa, and are brittle.

To toughen glassy polymers, it is common practice to fill them with μm-sized rubbery particles of, for example, polybutadiene (Bucknall, C. B. Toughened Plastics, 1st ed.; Applied Science Publishers Ltd., 1977). High-impact polystyrene (HIPS) is a well-known example of this class of materials (Bishnu P., P. et al. Mechanism of Toughening in Rubber Toughened Polyolefin—A Review. Polym-Plast Technol 2015, 54 (5), 462-473; Pearson, R. A. et al. Influence of Particle Size and Particle Size Distribution on Toughening Mechanisms in Rubber-Modified Epoxies. J. Mater. Sci. 1991, 26 (14), 3828-3844). Alternatively, glassy polymers can be “filled” by covalently interconnecting them with blocks of polyisoprene or polybutadiene, and relying on block copolymer self-assembly to form mesostructures including rubbery domains embedded within a glassy matrix. Thermoplastic elastomers like poly(vinylcyclohexane-b-ethylene-b-vinylcyclohexane) (CEC) and CECEC are examples of this type of material (Ryu, C. Y. et al. Chain Architecture Effects on Deformation and Fracture of Block Copolymers with Unentangled Matrices. Macromolecules 2002, 35 (6), 2157-2166). Both strategies rely on rubbery particles delocalizing stress concentrations within the polymers to mitigate the nucleation and growth of microscopic cracks.

In an aspect, provided is a tetrablock polymer including the formula ABAC, wherein A, B and C are each blocks of the polymer, where A is a glassy block; B is a rubbery block; and C is a hydrophilic block.

Glassy polymer blocks are differentiated from rubbery polymer blocks by the rate of segmental motion of the polymer chains. Polymers in the glassy state do not have the rapid molecular motion that permit rubbery polymers their liquid-like nature and their ability to adjust segmental configurations rapidly over large distances (e.g., >0.5 nm). Glassy polymers exist in a non-equilibrium state with entangled chains immobilized in frozen conformations. The glass transition temperature (T_{g}) is the dividing point between the rubbery or glassy state. Above the T_{g}, the polymer exists in the rubbery state; below the T_{g}, the polymer exists in the glassy state. Rigid, glassy polymers describe polymers with rigid polymer chain backbones that have limited intramolecular rotational mobility and are often characterized by having high glass transition temperatures.

In some aspects, the glassy block can have a T_{g} of at least about 75° C. (e.g., at least about 80° C., at least about 85° C., at least about 90° C., at least about 95° C., at least about 100° C., at least about 105° C., at least about 110° C., at least about 115° C., at least about 120° C., at least about 125° C., at least about 130° C., at least about 135° C., at least about 140° C., at least about 145° C., at least about 150° C., at least about 155° C., at least about 160° C., at least about 165° C., at least about 170° C., at least about 175° C., at least about 180° C., at least about 185° C., at least about 190° C., at least about 195° C., at least about 200° C.). In some aspects, the glassy block can have a T_{g} of up to about 200° C. (e.g., up to about 195° C., up to about 190° C., up to about 185° C., up to about 180° C., up to about 175° C., up to about 170° C., up to about 165° C., up to about 160° C., up to about 155° C., up to about 150° C., up to about 145° C., up to about 140° C., up to about 135° C., up to about 130° C., up to about 125° C., up to about 120° C., up to about 115° C., up to about 110° C., up to about 105° C., up to about 100° C., up to about 95° C., up to about 90° C., up to about 85° C., up to about 80° C., up to about 75° C.).

It is considered that the glassy block can have a T_{g} ranging from any of the minimum values described above to any of the maximum values described above. For example, in some aspects, the glassy block can have a T_{g} of from about 75° C. to about 200° C. (e.g., from about 80° C. to about 195° C., from about 85° C. to about 190° C., from about 90° C. to about 185° C., from about 95° C. to about 180° C., from about 100° C. to about 175° C., from about 105° C. to about 170° C., from about 110° C. to about 165° C., from about 115° C. to about 160° C., from about 120° C. to about 155° C., from about 125° C. to about 150° C., from about 130° C. to about 145° C., from about 135° C. to about 140° C., from about 75° C. to about 140° C., from about 80° C. to about 135° C., from about 85° C. to about 130° C., from about 90° C. to about 125° C., from about 95° C. to about 120° C., from about 100° C. to about 115° C., from about 105° C. to about 110° C., from about 135° C. to about 200° C., from about 140° C. to about 195° C., from about 145° C. to about 190° C., from about 150° C. to about 185° C., from about 155° C. to about 180° C., from about 160° C. to about 175° C., from about 165° C. to about 170° C.).

In some aspects, the rubbery block can have a T_{g} of at least about −50° C. (e.g., at least about −45° C., at least about −40° C., at least about −35° C., at least about −30° C., at least about −25° C., at least about-20° C., at least about −15° C., at least about −10° C., at least about −5° C., at least about 0° C.). In some aspects, the rubbery block can have a T_{g} of up to about 0° C. (e.g., up to about −5° C., up to about −10° C., up to about −15° C., up to about −20° C., up to about −25° C., up to about −30° C., up to about −35° C., up to about −40° C., up to about −45° C., up to about −50° C.).

It is considered that the rubbery block can have a T_{g} ranging from any of the minimum values described above to any of the maximum values described above. For example, in some aspects, the rubbery block can have a T_{g} of from about −50° C. to about 0° C. (e.g., from about −45° C. to about −5° C., from about −40° C. to about −10° C., from about −35° C. to about −15° C., from about-30° C. to about −20° C., from about −50° C. to about −25° C., from about −45° C. to about −30° C., from about −40° C. to about −35° C., from about −25° C. to about 0° C., from about −20° C. to about −5° C., from about −15° C. to about −10° C.).

In some aspects, block B can have a low packing length to increase the entanglement density of the tetrablock polymer. For example, the entanglement density of the tetrablock polymer, vₑ, can result from the volume-weighted average of the entanglement density of each block:

$${v}_{e} = {\sum }_{i} {ϕ}_{i} \frac{{ρ}_{i} {N}_{A}}{{M}_{e , i}} \qquad ( EQ . 1 )$$

where i corresponds to the A, B, or C blocks, φᵢ is the volume fraction of the i^{th} block, ρᵢ is the mass density of the i^{th} block, N_{A} is Avogadro's number, and M_{e,i} is the entanglement molecular weight of the i^{th} block.

In some aspects, the entanglement density of the polymer can be at least about 4×10²⁵ chains/m³ (e.g., at least about 5×10²⁵ chains/m³, at least about 6×10²⁵ chains/m³, at least about 7×10²⁵ chains/m³, at least about 8×10²⁵ chains/m³, at least about 9×10²⁵ chains/m³, at least about 10×10²⁵ chains/m³, at least about 11×10²⁵ chains/m³, at least about 12×10²⁵ chains/m³, at least about 13×10²⁵ chains/m³, at least about 14×10²⁵ chains/m³, at least about 15×10²⁵ chains/m³, at least about 16×10²⁵ chains/m³, at least about 17×10²⁵ chains/m³, at least about 18×10²⁵ chains/m³). In some aspects, the entanglement density of the polymer can be up to about 18×10²⁵ chains/m³ (e.g., up to about 17×10²⁵ chains/m³, up to about 16×10²⁵ chains/m³, up to about 15×10²⁵ chains/m³, up to about 14×10²⁵ chains/m³, up to about 13×10²⁵ chains/m³, up to about 12×10²⁵ chains/m³, up to about 11×10²⁵ chains/m³, up to about 10×10²⁵ chains/m³, up to about 9×10²⁵ chains/m³, up to about 8×10²⁵ chains/m³, up to about 7×10²⁵ chains/m³, up to about 6×10²⁵ chains/m³, up to about 5×10²⁵ chains/m³, up to about 4×10²⁵ chains/m³).

It is considered that the entanglement density of the polymer can range from any of the minimum values described above to any of the maximum values described above. For example, in some aspects, the entanglement density of the polymer can be from about 4×10²⁵ chains/m³ to about 18×10²⁵ chains/m³ (e.g., from about 5×10²⁵ chains/m³ to about 17×10²⁵ chains/m³, from about 6×10²⁵ chains/m³ to about 16×10²⁵ chains/m³, from about 7×10²⁵ chains/m³ to about 15×10²⁵ chains/m³, from about 8×10²⁵ chains/m³ to about 14×10²⁵ chains/m³, from about 9×10²⁵ chains/m³ to about 13×10²⁵ chains/m³, from about 10×10²⁵ chains/m³ to about 12×10²⁵ chains/m³, from about 4×10²⁵ chains/m³ to about 11×10²⁵ chains/m³, from about 5×10²⁵ chains/m³ to about 10×10²⁵ chains/m³, from about 6×10²⁵ chains/m³ to about 9×10²⁵ chains/m³, from about 7×10²⁵ chains/m³ to about 8×10²⁵ chains/m³, from about 11×10²⁵ chains/m³ to about 18×10²⁵ chains/m³, from about 12×10²⁵ chains/m³ to about 17×10²⁵ chains/m³, from about 13×10²⁵ chains/m³ to about 16×10²⁵ chains/m³, from about 14×10²⁵ chains/m³ to about 15×10²⁵ chains/m³).

In some aspects, block A can be polystyrene, polyvinylcyclohexane, polymethylmethacrylate, polyacrylonitrile, styrene-acrylonitrile copolymer, polyvinylacetate, polyvinylchloride, or any combination thereof.

In some aspects, block B can be polyisoprene, polybutadiene, polyethylene, polypropylene, polyethylene alt-propylene, acrylonitrile-butadiene copolymer, butyl acrylate-butadiene copolymer, polyisoprene, butadiene-methyl methacrylate copolymer, butyl acrylate-methyl methacrylate copolymer, butadiene-ethyl acrylate copolymer, ethylene-propylene copolymer, ethylene-propylene-diene-based copolymer, ethylene-isoprene copolymer, ethylene-methyl acrylate copolymer, polyorganosiloxane-acryl-based copolymer containing polyorganosiloxane and alkyl(meth)acrylate rubber, or any combination thereof.

Hydrophilic polymer blocks can form hydrogen bonds with water. In some aspects, block C can be poly-4-vinylpyridine, polyethylene oxide, polyvinyl alcohol, a copolymer of vinyl alcohol and alkene monomers, a copolymer of poly(ethylene glycol), polyacrylamide (PAM), poly(N-isopropylacrylamide) (PNIPAM), poly(acrylic acid), polymethacrylate, an acrylic polymer, a maleic anhydride copolymer, a sulfonated polyester, a polysaccharide, or any combination thereof.

In some aspects, block C can include a quaternized ammonium ion, pyridinium, piperazinium, another suitable nucleophile, or any combination thereof.

In some aspects, block A can be at least about 25 wt. % (e.g., at least about 30 wt. %, at least about 35 wt. %, at least about 40 wt. %, at least about 45 wt. %, at least about 50 wt. %, at least about 55 wt. %, at least about 60 wt. %, at least about 65 wt. %, at least about 70 wt. %, at least about 75 wt. %, at least about 80 wt. %) of the polymer. In some aspects, block A can be up to about 80 wt. % (e.g., up to about 75 wt. %, up to about 70 wt. %, up to about 65 wt. %, up to about 60 wt. %, up to about 55 wt. %, up to about 50 wt. %, up to about 45 wt. %, up to about 40 wt. %, up to about 35 wt. %, up to about 30 wt. %, up to about 25 wt. %) of the polymer.

It is considered that block A can be a wt. % of the polymer ranging from any of the minimum values described above to any of the maximum values described above. For example, in some aspects, block A can be from about 25 wt. % to about 80 wt. % (e.g., from about 30 wt. % to about 75 wt. %, from about 35 wt. % to about 70 wt. %, from about 40 wt. % to about 65 wt. %, from about 45 wt. % to about 60 wt. %, from about 50 wt. % to about 55 wt. %, from about 25 wt. % to about 55 wt. %, from about 30 wt. % to about 50 wt. %, from about 35 wt. % to about 45 wt. %, from about 50 wt. % to about 80 wt. %, from about 55 wt. % to about 75 wt. %, from about 60 wt. % to about 70 wt. %) of the polymer.

In some aspects, block B can be at least about 5 wt. % (e.g., at least about 6 wt. %, at least about 7 wt. %, at least about 8 wt. %, at least about 9 wt. %, at least about 10 wt. %, at least about 15 wt. %, at least about 20 wt. %, at least about 25 wt. %, at least about 30 wt. %, at least about 35 wt. %, at least about 40 wt. %) of the polymer. In some aspects, block B can be up to about 40 wt. % (e.g., up to about 35 wt. %, up to about 30 wt. %, up to about 25 wt. %, up to about 20 wt. %, up to about 15 wt. %, up to about 10 wt. %, up to about 9 wt. %, up to about 8 wt. %, up to about 7 wt. %, up to about 6 wt. %, up to about 5 wt. %) of the polymer.

It is considered that block B can be a wt. % of the polymer ranging from any of the minimum values described above to any of the maximum values described above. For example, in some aspects, block B can be from about 5 wt. % to about 40 wt. % (e.g., from about 6 wt. % to about 35 wt. %, from about 7 wt. % to about 30 wt. %, from about 8 wt. % to about 25 wt. %, from about 9 wt. % to about 20 wt. %, from about 10 wt. % to about 15 wt. %, from about 5 wt. % to about 15 wt. %, from about 6 wt. % to about 10 wt. %, from about 7 wt. % to about 9 wt. %, from about 10 wt. % to about 40 wt. %, from about 15 wt. % to about 35 wt. %, from about 20 wt. % to about 30 wt. %) of the polymer.

In some aspects, block C can be at least about 10 wt. % (e.g., at least about 11 wt. %, at least about 12 wt. %, at least about 13 wt. %, at least about 14 wt. %, at least about 15 wt. %, at least about 16 wt. %, at least about 17 wt. %, at least about 18 wt. %, at least about 19 wt. %, at least about 20 wt. %, at least about 21 wt. %, at least about 22 wt. %, at least about 23 wt. %, at least about 24 wt. %, at least about 25 wt. %, at least about 26 wt. %, at least about 27 wt. %, at least about 28 wt. %, at least about 29 wt. %, at least about 30 wt. %) of the polymer. In some aspects, block C can be up to about 30 wt. % (e.g., up to about 29 wt. %, up to about 28 wt. %, up to about 27 wt. %, up to about 25 wt. %, up to about 24 wt. %, up to about 23 wt. %, up to about 22 wt. %, up to about 21 wt. %, up to about 20 wt. %, up to about 19 wt. %, up to about 18 wt. %, up to about 17 wt. %, up to about 16 wt. %, up to about 15 wt. %, up to about 14 wt. %, up to about 13 wt. %, up to about 12 wt. %, up to about 11 wt. %, up to about 10 wt. %) of the polymer.

It is considered that block C can be a wt. % of the polymer ranging from any of the minimum values described above to any of the maximum values described above. For example, in some aspects, block C can be from about 10 wt. % to about 30 wt. % (e.g., from about 11 wt. % to about 29 wt. %, from about 12 wt. % to about 28 wt. %, from about 13 wt. % to about 27 wt. %, from about 14 wt. % to about 26 wt. %, from about 15 wt. % to about 25 wt. %, from about 16 wt. % to about 24 wt. %, from about 17 wt. % to about 23 wt. %, from about 18 wt. % to about 22 wt. %, from about 19 wt. % to about 21 wt. %, from about 10 wt. % to about 20 wt. %, from about 11 wt. % to about 19 wt. %, from about 12 wt. % to about 18 wt. %, from about 13 wt. % to about 17 wt. %, from about 14 wt. % to about 16 wt. %, from about 20 wt. % to about 30 wt. %, from about 21 wt. % to about 29 wt. %, from about 22 wt. % to about 28 wt. %, from about 23 wt. % to about 27 wt. %, from about 24 wt. % to about 26 wt. %) of the polymer.

In some aspects, the weight % of the different blocks can be measured by end group analysis in a 1H NMR spectra.

In some aspects, block A and block B can be present in the polymer at a ratio of at least about 2:1 (e.g., at least about 2.2:1, at least about 2.4:1, at least about 2.6:1, at least about 2.8:1, at least about 3:1, at least about 3.2:1, at least about 3.4:1, at least about 3.6:1, at least about 3.8:1, at least about 4:1, at least about 4.2:1, at least about 4.4:1, at least about 4.6:1, at least about 4.8:1, at least about 5:1, at least about 5.2:1, at least about 5.4:1, at least about 5.6:1, at least about 5.8:1, at least about 6:1). In some aspects, block A and block B can be present in the polymer at a ratio of up to about 6:1 (e.g., up to about 5.8:1, up to about 5.6:1, up to about 5.4:1, up to about 5.2:1, up to about 5:1, up to about 4.8:1, up to about 4.6:1, up to about 4.4:1, up to about 4.2:1, up to about 4:1, up to about 3.8:1, up to about 3.6:1, up to about 3.4:1, up to about 3.2:1, up to about 3:1, up to about 2.8:1, up to about 2.6:1, up to about 2.4:1, up to about 2.2:1, up to about 2:1).

It is considered that block A and block B can be present in the polymer at a ratio ranging from any of the minimum values described above to any of the maximum values described above. For example, in some aspects, block A and block B can be present in the polymer at a ratio of from about 2:1 to about 6:1 (e.g., from about 2.2:1 to about 5.8:1, from about 2.4:1 to about 5.6:1, from about 2.6:1 to about 5.4:1, from about 2.8:1 to about 5.2:1, from about 3:1 to about 5:1, from about 3.2:1 to about 4.8:1, from about 3.4:1 to about 4.6:1, from about 3.6:1 to about 4.4:1, from about 3.8:1 to about 4.2:1, from about 2:1 to about 4:1, from about 2.2:1 to about 3.8:1, from about 2.4:1 to about 3.6:1, from about 2.6:1 to about 3.4:1, from about 2.8:1 to about 3.2:1, from about 4:1 to about 6:1, from about 4.2:1 to about 5.8:1, from about 4.4:1 to about 5.6:1, from about 4.6:1 to about 5.4:1, from about 4.8:1 to about 5.2:1).

In some aspects, the polymer can have a molecular weight (e.g., number average molecular weight) of at least about 50 kDa (e.g., at least about 55 kDa, at least about 60 kDa, at least about 65 kDa, at least about 70 kDa, at least about 75 kDa, at least about 80 kDa, at least about 85 kDa, at least about 90 kDa, at least about 95 kDa, at least about 100 kDa, at least about 110 kDa, at least about 120 kDa, at least about 130 kDa, at least about 140 kDa, at least about 150 kDa, at least about 160 kDa, at least about 170 kDa, at least about 180 kDa, at least about 190 kDa, at least about 200 kDa, at least about 210 kDa, at least about 220 kDa, at least about 230 kDa, at least about 240 kDa, at least about 250 kDa). In some aspects, the polymer can have a molecular weight of up to about 250 kDa (e.g., up to about 240 kDa, up to about 230 kDa, up to about 220 kDa, up to about 210 kDa, up to about 200 kDa, up to about 190 kDa, up to about 180 kDa, up to about 170 kDa, up to about 160 kDa, up to about 150 kDa, up to about 140 kDa, up to about 130 kDa, up to about 120 kDa, up to about 110 kDa, up to about 100 kDa, up to about 95 kDa, up to about 90 kDa, up to about 85 kDa, up to about 80 kDa, up to about 75 kDa, up to about 70 kDa, up to about 65 kDa, up to about 60 kDa, up to about 55 kDa, up to about 50 kDa).

It is considered that the polymer can have a molecular weight ranging from any of the minimum values described above to any of the maximum values described above. For example, in some aspects, the polymer can have a molecular weight of from about 50 kDa to about 250 kDa (e.g., from about 55 kDa to about 240 kDa, from about 60 kDa to about 230 kDa, from about 65 kDa to about 220 kDa, from about 70 kDa to about 210 kDa, from about 75 kDa to about 200 kDa, from about 80 kDa to about 190 kDa, from about 85 kDa to about 180 kDa, from about 90 kDa to about 170 kDa, from about 95 kDa to about 160 kDa, from about 100 kDa to about 150 kDa, from about 110 kDa to about 140 kDa, from about 120 kDa to about 130 kDa, from about 50 kDa to about 130 kDa, from about 55 kDa to about 120 kDa, from about 60 kDa to about 110 kDa, from about 65 kDa to about 100 kDa, from about 70 kDa to about 95 kDa, from about 75 kDa to about 90 kDa, from about 80 kDa to about 85 kDa, from about 120 kDa to about 250 kDa, from about 130 kDa to about 240 kDa, from about 140 kDa to about 230 kDa, from about 150 kDa to about 220 kDa, from about 160 kDa to about 210 kDa, from about 170 kDa to about 200 kDa, from about 180 kDa to about 190 kDa).

In some aspects, the molecular weight of the polymer can be measured by end group analysis in a ¹H NMR spectra.

In some aspects, the polymer can be a poly(styrene-b-isoprene-b-styrene-b-4-vinylpyridine) or poly(styrene-b-(ethylene-alt-propylene)-b-styrene-b-ethylene oxide).

In another aspect, provided is a membrane, including: any of the disclosed polymers organized to define pores with an average pore diameter of about 15 nm to about 50 nm.

In some aspects, the average pore diameter can be at least about 15 nm (e.g., at least about at least about 16 nm, at least about 17 nm, at least about 18 nm, at least about 19 nm, at least about 20 nm, at least about 21 nm, at least about 22 nm, at least about 23 nm, at least about 24 nm, at least about 25 nm, at least about 26 nm, at least about 27 nm, at least about 28 nm, at least about 29 nm, at least about 30 nm, at least about 35 nm, at least about 40 nm, at least about 45 nm, at least about 50 nm). In some aspects, the average pore diameter can be up to about 50 nm (e.g., up to about 45 nm, up to about 40 nm, up to about 35 nm, up to about 30 nm, up to about 29 nm, up to about 28 nm, up to about 27 nm, up to about 26 nm, up to about 25 nm, up to about 24 nm, up to about 23 nm, up to about 22 nm, up to about 21 nm, up to about 20 nm, up to about 19 nm, up to about 18 nm, up to about 17 nm, up to about 16 nm, up to about 15 nm).

It is considered that the average pore diameter can range from any of the minimum values described above to any of the maximum values described above. For example, in some aspects, the average pore diameter can be from about 15 nm to about 50 nm (e.g., from about 16 nm to about 45 nm, from about 17 nm to about 40 nm, from about 18 nm to about 35 nm, from about 19 nm to about 30 nm, from about 20 nm to about 29 nm, from about 21 nm to about 28 nm, from about 22 nm to about 27 nm, from about 23 nm to about 26 nm, from about 24 nm to about 25 nm, from about 15 nm to about 25 nm, from about 16 nm to about 24 nm, from about 17 nm to about 23 nm, from about 18 nm to about 22 nm, from about 19 nm to about 21 nm, from about 25 nm to about 50 nm, from about 26 nm to about 45 nm, from about 27 nm to about 40 nm, from about 28 nm to about 35 nm, from about 29 nm to about 30 nm).

In some aspects, the standard deviation of the pore size over the average pore size can be less than about 0.25 (e.g., less than about 0.2, less than about 0.15, less than about 0.1, less than about 0.09, less than about 0.08, less than about 0.07, less than about 0.06, less than about 0.05, less than about 0.04, less than about 0.03, less than about 0.02, less than about 0.01). In some aspects, the standard deviation of the pore size over the average pore size can be about 0.01 or more (e.g., about 0.02 or more, about 0.03 or more, about 0.04 or more, about 0.05 or more, about 0.06 or more, about 0.07 or more, about 0.08 or more, about 0.09 or more, about 0.1 or more, about 0.15 or more, about 0.2 or more, about 0.25 or more).

It is considered that the standard deviation of the pore size over the average pore size can range from any of the minimum values described above to any of the maximum values described above. For example, in some aspects, the standard deviation of the pore size over the average pore size can be from about 0.01 to about 0.25 (e.g., from about 0.02 to about 0.2, from about 0.03 to about 0.15, from about 0.04 to about 0.1, from about 0.05 to about 0.09, from about 0.06 to about 0.08, from about 0.01 to about 0.1, from about 0.02 to about 0.09, from about 0.03 to about 0.08, from about 0.04 to about 0.07, from about 0.05 to about 0.06, from about 0.1 to about 0.25, from about 0.15 to about 0.2).

In yet another aspect, provided is a supported ionic liquid membrane, including: any of the disclosed membranes and an ionic liquid within the pores.

The term “ionic liquid” has many definitions in the art, but is used herein to refer to salts (i.e., an ionic compound of cations and anions) that are liquid at a temperature of at or below about 100° C. That is, at one or more temperature ranges or points at or below about 100° C. the disclosed ionic liquid compositions are liquid; although, it is understood that they can be solids at other temperature ranges or points. See e.g., Wasserscheid and Keim, Angew Chem Int Ed Engl, 2000, 39:3772; and Wasserscheid, “Ionic Liquids in Synthesis,” 1^{st} Ed., Wiley-VCH, 2002.

In some examples, the ionic liquid can be a liquid at a temperature of about 100° C. or less, about 90° C. or less, about 80° C. or less, about 70° C. or less, about 60° C. or less, about 50° C. or less, about 40° C. or less, about 30° C. or less, about 20° C. or less, about 10° C. or less, about 0° C. or less, about −10° C. or less, about −20° C. or less, or about −30° C. or less). Further, in some examples the disclosed ionic liquids can be liquid over a range of temperatures. For example, the disclosed ionic liquids can be liquids over a range of about 1° C. or more (e.g., about 2° C. or more, about 3° C. or more, about 4° C. or more, about 5° C. or more, about 6° C. or more, about 7° C. or more, about 8° C. or more, about 9° C. or more, about 10° C. or more, about 11° C. or more, about 12° C. or more, about 13° C. or more, about 14° C. or more, about 15° C. or more, about 16° C. or more, about 17° C. or more, about 18° C. or more, about 19° C. or more, or about 20° C. or more). Such temperature ranges can begin and/or end at any of the temperature points disclosed above.

In further examples, the disclosed ionic liquids can be liquid at temperature from about −30° C. to about 100° C. (e.g., from about −20° C. to about 90° C., from about −10° C. to about 80° C., from about 0° C. to about 70° C., from about 10° C. to about 60° C., from about 20° C. to about 50° C., from about 30° C. to about 40° C., from about −30° C. to about 40° C., from about −20° C. to about 30° C., from about −10° C. to about 20° C., from about 0° C. to about 10° C., from about 30° C. to about 100° C., from about 40° C. to about 90° C., from about 50° C. to about 80° C., from about 60° C. to about 70° C.).

Further, exemplary properties of ionic liquids are high ionic conductivity, non-volatility, non-flammability, high thermal stability, wide temperature for liquid phase, high solubility of many gases, liquids and solids, and non-coordinating. For a review of ionic liquids see, for example, Welton, Chem Rev., 99:2071-2083, 1999; and Carlin et al., Advances in Nonaqueous Chemistry, Mamantov et al. Eds., VCH Publishing, New York, 1994. These references are incorporated by reference herein in their entireties for their teachings of ionic liquids.

The term “liquid” describes the compositions that are generally in amorphous, non-crystalline, or semi-crystalline state. For example, while some structured association and packing of cations and anions can occur at the atomic level, an ionic liquid composition can have minor amounts of such ordered structures and are therefore not crystalline solids. The compositions can be fluid and free-flowing liquids or amorphous solids such as glasses or waxes at temperatures at or below 100° C.

The ionic liquids of the present disclosure can include an organic cation and an organic or inorganic anion. The organic cation is typically formed by alkylation of a neutral organic species capable of holding a positive charge when a suitable anion is present.

Further, the ionic liquid can be composed of at least two different ions, each of which can independently and simultaneously introduce a specific characteristic to the composition not easily obtainable with traditional dissolution and formulation techniques. Thus, by providing different ions and ion combinations, one can change the characteristics or properties of the disclosed compositions in a way not seen by simply preparing various crystalline salt forms. Examples of characteristics that can be controlled in the disclosed compositions include, but are not limited to, melting, solubility control, and rate of dissolution. It is this multi-nature/functionality of the disclosed ionic liquid compositions which allows one to fine-tune or design in very specific desired material properties. For example, the ionic liquids of the present disclosure can include at least one cation and at least one anion.

The organic cation of the ionic liquids disclosed herein can include a linear, branched, or cyclic heteroalkyl unit or an aryl group. The term “heteroalkyl” refers to a cation as disclosed herein including one or more heteroatoms chosen from nitrogen, oxygen, sulfur, boron, or phosphorus capable of forming a cation. The heteroatom can be a part of a ring formed with one or more other heteroatoms, for example, pyridinyl, imidazolinyl rings, that can have substituted or unsubstituted linear or branched alkyl units attached thereto. In addition, the cation can be a single heteroatom wherein a sufficient number of substituted or unsubstituted linear or branched alkyl units are attached to the heteroatom such that a cation is formed. For example, the alkylmethylimidazolium cation [Cₙmim] where n is an integer of from 1 to 8 can be used. In other specific examples, ionic liquids with the cation [C₁₋₄mim] can be used.

Other non-limiting examples of heterocyclic and heteroaryl units that can be alkylated to form cationic units include imidazole, pyrazoles, thiazoles, isothiazoles, azathiazoles, oxothiazoles, oxazines, oxazolines, oxazaboroles, dithiazoles, triazoles, selenazoles, oxaphospholes, pyrroles, boroles, furans, thiophenes, phospholes, pentazoles, indoles, indolines, oxazoles, isothiazoles, tetrazoles, benzofurans, dibenzofurans, benzothiophenes, dibenzothoiphenes, thiadiazoles, pyridines, pyrimidines, pyrazines, pyridazines, piperazines, piperidines, morpholines, pyrans, anilines, phthalazines, quinazolines, and quinoxalines.

The following are examples of heterocyclic units that are suitable for forming a heterocyclic cation unit of the disclosed ionic liquids:

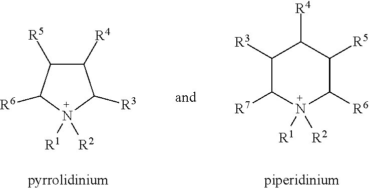

The following are further examples of heterocyclic units that are suitable for forming a cyclic heteroalkyl cation unit of the disclosed ionic liquids:

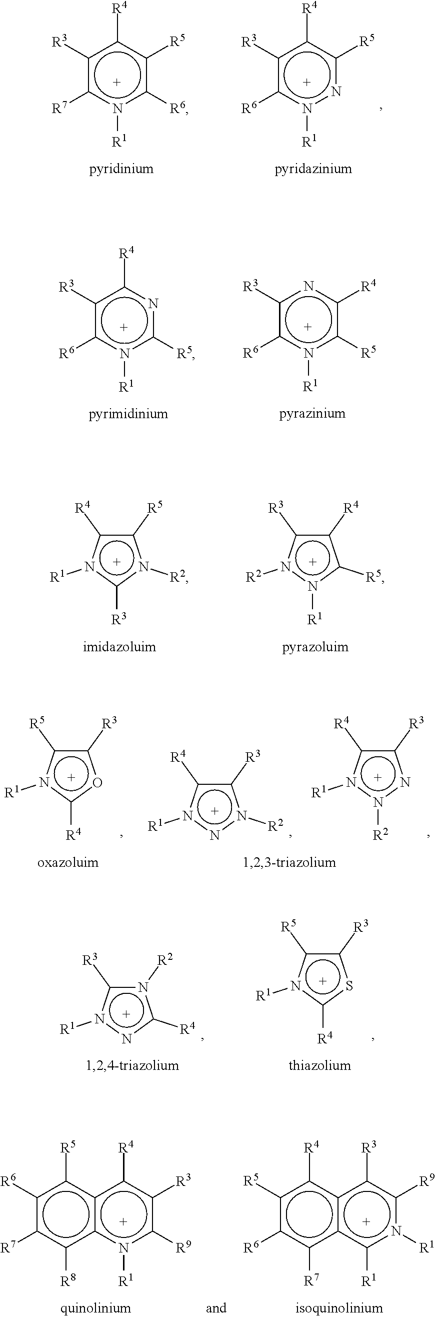

where each R¹ and R² can be, independently, a substituted or unsubstituted linear, branched, or cyclic C₁-C₆ alkyl, or substituted or unsubstituted linear, branched, or cyclic C₁-C₆ alkoxy; each R³, R⁴, R⁵, R⁶, R⁷, R⁸, and R⁹ can be, independently, hydrogen, substituted or unsubstituted linear, branched, or cyclic C₁-C₆ alkyl, substituted or unsubstituted linear, branched, or cyclic C₁-C₆ alkoxy, or substituted or unsubstituted linear or branched, C₁-C₆ alkoxyalkyl.

The following includes yet another set of examples of heterocyclic units that are suitable for forming heterocyclic dication units of the disclosed ionic liquids and are referred to as such or as “geminal ionic liquids:” See Armstrong, D. W. et al., Structure and properties of high stability geminal dicationic ionic liquids, J. Amer. Chem. Soc. 2005; 127 (2): 593-604; and Rogers, R. D. et al., Mercury (II) partitioning from aqueous solutions with a new, hydrophobic ethylene-glycol functionalized bis-imidazolium ionic liquid, Green Chem. 2003; 5:129-135 included herein by reference in its entirety.

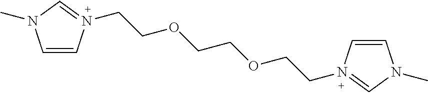

### 1,1′-[1,2-ethanediylbis(oxy-1,2-ethanediyl)]bis [3-methyl-1H-imidazolium-1-yl]

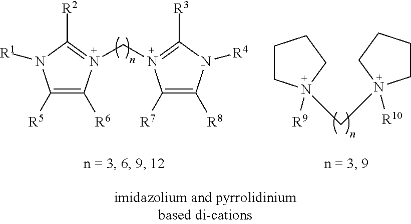

where R¹, R⁴, R⁹, and R¹⁰ can include a substituted or unsubstituted linear, branched, or cyclic C₁-C₆ alkyl, or substituted or unsubstituted linear, branched, or cyclic C₁-C₆ alkoxy; each R⁵, R⁶, R⁷, and R⁸ can be, independently, hydrogen, substituted or unsubstituted linear, branched, or cyclic C₁-C₆ alkyl, substituted or unsubstituted linear, branched, or cyclic C₁-C₆ alkoxy, or substituted or unsubstituted linear or branched, C₁-C₆ alkoxyalkyl.

The disclosed compositions can also comprise a tetraalkyl ammonium cation. Suitable tetraalkylammonium cations comprise four alkyl moieties, as disclosed herein. In one example, a tetraalkylammonium cation can comprise one long chain alkyl moiety (e.g., 10 or more carbon atoms in length) and three short chain alkyl moieties (e.g., less than 10 carbon atoms in length).

Some specific examples of tetraalkylammonium cations that can be included in the disclosed compositions include, but are not limited to, cetyl trimethyl ammonium, lauryl trimethyl ammonium, myristyl trimethyl ammonium, stearyl trimethyl ammonium, arachidyl trimethyl ammonium, or mixtures thereof. Other examples include, but are not limited to, cetyl dimethylethyl ammonium, lauryl dimethylethyl ammonium, myristyl dimethylethyl ammonium, stearyl dimethylethyl ammonium, arachidyl dimethylethyl ammonium, or mixtures thereof.

The disclosed compositions can also comprise a tetraalkyl phosphonium cation. Suitable tetraalkylphosphonium cations comprise four alkyl moieties, as disclosed herein. In some examples, a tetraalkylphosonium cation can comprise four short chain alkyl moieties (e.g., 10 or less carbon atoms in length), such as tetrabutylphoshonium. In some examples, a tetraalkylphosphonim cation can comprise other lengths of alkyl chains, such as a mixture of two short chain alkyl moieties (e.g., 10 or less carbon atoms in length) and two long chain alkyl moieties (e.g., 10 or more carbon atoms in length).

Also, any of the cations disclosed herein can be linked together (in same molecule) to form a dication, which are also suitable for use herein.

In some examples, the anions can be substituted or unsubstituted acyl units R¹⁰CO₂, for example, formate HCO₂⁻, acetate CH₃CO₂⁻ (also noted herein as [OAc]), propionate, CH₃CH₂CO₂⁻, butyrate CH₃CH₂CH₂CO₂⁻, and benzylate, C₆H₅CO₂⁻; substituted or unsubstituted sulfates: (R¹⁰O)S(═O)₂O⁻; substituted or unsubstituted sulfonates R¹⁰SO₃⁻, for example (CF₃) SO₃; substituted or unsubstituted phosphates: (R¹⁰O)₂P(═O)O⁻; and substituted or unsubstituted carboxylates: (R¹⁰O)C(═O)O⁻. Non-limiting examples of R¹⁰ include hydrogen; substituted or unsubstituted linear branched, and cyclic alkyl; substituted or unsubstituted linear, branched, and cyclic alkoxy; substituted or unsubstituted aryl; substituted or unsubstituted aryloxy; substituted or unsubstituted heterocyclic; substituted or unsubstituted heteroaryl; acyl; silyl; boryl; phosphino; amino; thio; and seleno. In some examples, the anion can be C₁₋₆ carboxylate.

Still further examples of anions are deprotonated amino acids, for example, isoleucine, alanine, leucine, asparagine, lysine, aspartic acid, methionine, cysteine, phenylalanine, glutamic acid, threonine, glutamine, tryptophan, glycine, valine, proline, selenocysteine, serine, tyrosine, arginine, histidine, ornithine, and taurine.

It is also contemplated that other anions can be used in some instances, such as halides, (i.e., F⁻, Cl⁻, Br⁻, and I⁻), CO₃²⁻; NO₂⁻, NO₃⁻, SO₄²⁻, CN⁻, arsenate (V), AsX₆ such as AsF₆⁻, and the like; stibate (V) (antimony), SbX₆ such as SbF₆⁻, and the like.

Other non-limiting examples of ionic liquid anions include substituted azolates, that is, five membered heterocyclic aromatic rings that have nitrogen atoms in either positions 1 and 3 (imidazolates); 1, 2, and 3 (1,2,3-triazolates); or 1, 2, 4 (1,2,4-triazolate). Pyrrolides and pyrazolides can be used as well. Substitutions to the ring occur at positions that are not located in nitrogen positions (these are carbon positions) and include CN (cyano-), NO₂ (nitro-), and NH₂ (amino) group appended to the heterocyclic azolate core. See US 2012/0222557, which is incorporated by reference herein for its teaching of ionic liquids that can be used herein.

In some examples of suitable ionic liquids, an anion can be chosen from formate, acetate, propionate, butyrate, (CF₃) SO₃⁻, (R¹⁰O)S(═O)₂O⁻; (R¹⁰O)₂P(═O)O⁻; (R¹⁰O)C(═O)O⁻; and R¹⁰CO₂⁻; each R¹⁰ can be independently C₁-C₆ alkyl. The anion portion of the ionic liquid can be written without the charge, for example, OAc, CHO₂, Cl, Br, RCH₃OPO₂, and PF₆.

In some examples, the ionic liquid can include a cation selected from the group consisting of:

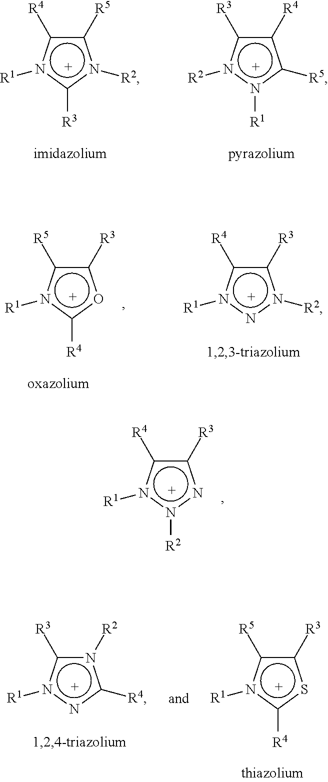

where each R¹ and R² can be, independently, a substituted or unsubstituted linear, branched, or cyclic C₁-C₆ alkyl, or substituted or unsubstituted linear, branched, or cyclic C₁-C₆ alkoxy; each R³, R⁴, R⁵, R⁶, R⁷, R⁸, and R⁹ can be, independently, hydrogen, substituted or unsubstituted linear, branched, or cyclic C₁-C₆ alkyl, substituted or unsubstituted linear, branched, or cyclic C₁-C₆ alkoxy, or substituted or unsubstituted linear or branched, C₁-C₆ alkoxyalkyl; and an anion selected from the group consisting of C₁₋₆ carboxylate, halide, CO₃²; NO₂⁻, NO₃⁻, SO₄²⁻, CN⁻, R¹⁰CO₂⁻, (R¹⁰O)₂P(═O)O⁻, (R¹⁰O)S(═O)₂O⁻, or (R¹⁰O)C(═O)O⁻; where R¹⁰ can be hydrogen; substituted or unsubstituted linear, branched, or cyclic alkyl; substituted or unsubstituted linear, branched, or cyclic alkoxy; substituted or unsubstituted aryl; substituted or unsubstituted aryloxy; substituted or unsubstituted heterocyclic; and substituted or unsubstituted heteroaryl.

### Methods

In an aspect, provided is method of forming a membrane, including: a. casting a solution including any of the disclosed polymers, a solvent for the polymer, and a salt onto a substrate; b. drying the cast solution, and c. contacting the dried, cast solution with a nonsolvent.

In some aspects, the solvent can include one or more of dioxane, tetrahydrofuran, dimethylformamide, dimethylacetamide (DMAc), N-methyl-2-pyrrolidone (NMP), acetone, and sulfolane.

In some aspects, the salt can be copper bistriflimide or copper bis(pentafluorocthylsulfonyl) imide.

In some aspects, the salt can be Cu^{II}(acetate)₂, Mg^{II}(acetate)₂, Fe^{II}(acetate)₂, Co^{II}(acetate)₂, Ni^{II} (acetate)₂, Cu^{II} (BF₄)₂, or Cu^{II} (Cl)₂.

In some aspects, the drying step can be at least about 1 second (e.g., at least about 2 seconds, at least about 3 seconds, at least about 4 seconds, at least about 5 seconds, at least about 6 seconds, at least about 7 seconds, at least about 8 seconds, at least about 9 seconds, at least about 10 seconds, at least about 15 seconds, at least about 20 seconds, at least about 25 seconds, at least about 30 seconds, at least about 35 seconds, at least about 40 seconds, at least about 45 seconds, at least about 50 seconds, at least about 55 seconds, at least about 60 seconds, at least about 65 seconds, at least about 70 seconds, at least about 75 seconds). In some aspects, the drying step can be up to about 75 seconds (e.g., up to about 70 seconds, up to about 65 seconds, up to about 60 seconds, up to about 55 seconds, up to about 50 seconds, up to about 45 seconds, up to about 40 seconds, up to about 35 seconds, up to about 30 seconds, up to about 25 seconds, up to about 20 seconds, up to about 15 seconds, up to about 10 seconds, up to about 9 seconds, up to about 8 seconds, up to about 7 seconds, up to about 6 seconds, up to about 5 seconds, up to about 4 seconds, up to about 3 seconds, up to about 2 seconds, up to about 1 seconde).

It is considered that the drying step can be a duration ranging from any of the minimum values described above to any of the maximum values described above. For example, in some aspects, the drying step can be from about 1 second to about 75 seconds (e.g., from about 2 seconds to about 70 seconds, from about 3 seconds to about 65 seconds, from about 4 seconds to about 60 seconds, from about 5 seconds to about 55 seconds, from about 6 seconds to about 50 seconds, from about 7 seconds to about 45 seconds, from about 8 seconds to about 40 seconds, from about 9 seconds to about 35 seconds, from about 10 seconds to about 30 seconds, from about 15 seconds to about 25 seconds, from about 1 second to about 20 seconds, from about 2 seconds to about 15 seconds, from about 3 seconds to about 10 seconds, from about 4 seconds to about 9 seconds, from about 5 seconds to about 8 seconds, from about 6 seconds to about 7 seconds, from about 20 seconds to about 75 seconds, from about 25 seconds to about 70 seconds, from about 30 seconds to about 65 seconds, from about 35 seconds to about 60 seconds, from about 40 seconds to about 55 seconds, from about 45 seconds to about 50 seconds).

In another aspect, provided is a method of purifying a liquid or gas, including: contacting any of the disclosed membranes with the liquid or gas.

In some aspects, the method can generate purified light hydrocarbons (e.g., methane, ethane, propane), purified oxygen, purified nitrogen, or purified carbon dioxide. In some such aspects, the method can be carries out using a constant volume, variable pressure pure gas permeation setup.

In some aspects, the method can be used to purify pharmaceuticals, viruses, bacteria, or other organic material on a size scale of about 100 nm or more.

### EXAMPLES

The following examples are set forth below to illustrate the methods and results according to the disclosed subject matter. These examples are not intended to include all aspects of the subject matter disclosed herein but rather to illustrate representative methods and results. These examples are not intended to exclude equivalents and variations of the present invention, which are apparent to one skilled in the art.

Efforts have been made to ensure accuracy with respect to numbers (e.g., amounts, temperature, etc.), but some errors and deviations should be accounted for. Unless indicated otherwise, parts are parts by weight, the temperature is in ° C. or is at ambient temperature, and pressure is at or near atmospheric. Numerous variations and combinations of reaction conditions, e.g., component concentrations, temperatures, pressures, and other reaction ranges and conditions, can be used to optimize the product purity and yield obtained from the described process. Only reasonable and routine experimentation will be required to optimize such process conditions.

### Materials, Methods, and Equipment

Styrene (Thermo Scientific, 99%), isoprene (Thermo Scientific, 98%), sec-butyllithium (Sigma Aldrich, 1.4 M in cyclohexane), calcium hydride (Thermo Scientific, ca. 93%), dibutylmagnesium (Sigma Aldrich, 1.0 M in heptane), ethylene oxide (Praxair, 99.9%), potassium in mineral oil (Millipore Sigma, >99%), and naphthalene (Millipore Sigma, 98%) were all used as received unless otherwise specified. 4-methylbenzenesulphonylhydrazide (Thermo Scientific, 97%) was recrystallized from anhydrous ethanol before use. Anhydrous tetrahydrofuran, toluene, and cyclohexane were all obtained from a JC Meyer solvent system. Deionized (DI) water at ca. 23° C., sourced from a Milli-Q Advantage A-10 system fed with RO water, was used as the nonsolvent in SNIPS. 1,4-dioxane (DOX) (Sigma-Aldrich, 99.8%), tetrahydrofuran (THF) (Sigma-Aldrich, 99.9%), and dimethylformamide (DMF) (Sigma-Aldrich, 99.8%) were used as received in the casting dope solutions. Polystyrene-b-poly(4-vinylpyridine) (SV, Mₙ^{PS}=190 kg/mol, Mₙ^{P4VP}=64 kg/mol) was purchased from Polymer Source, Inc. and used as received. The WHATMAN™ NUCLEOPORE™ polycarbonate track-etched membrane (0.05 μm average pore size, 47 mm diameter) was purchased from Sigma-Aldrich and used as received. Poly(4-vinylpyridine) (P4VP, M_{w}=160 kg/mol) was purchased from Sigma-Aldrich and used as received. Unless otherwise noted, all other solvents were ACS reagent grade, purchased from Acros Organics, Fisher Scientific, or Sigma-Aldrich, and used without further purification. CDCl₃ and CD₂Cl₂ were purchased from Cambridge Isotope Laboratory.

¹H NMR spectroscopy was performed on a 400 MHz Agilent MR spectrometer at room temperature and referenced to the residual solvent signal of CDCl₃ (7.26 ppm) or CD₂Cl₂ (5.32 ppm).

Size exclusion chromatography (SEC) was carried out on an Agilent system with a 1260 Infinity isocratic pump, degasser, and thermostatted column chamber held at 30° C. that contained an Agilent PLgel 10 μm MIXED-D column with an operating range of 200-400,000 g/mol relative to polystyrene standards. Chloroform was used as the mobile phase. This system was equipped with an Agilent 1260 Infinity refractometer and bio-inert multi-detector suite featuring dual-angle static and dynamic light scattering detection.

A TA Instruments Q500 TGA was used to examine the solvent fraction in the dense films and the mesoporous membranes. Samples weighing 5-10 mg were loaded onto a platinum pan, and their mass loss was tracked from 25 to 800° C. at a heating rate of 5° C./min. All experiments were performed using a N₂ flow rate of 10 mL/min.

Small-angle X-ray scattering (SAXS) was employed to probe the ordering of polymer dispersions in the solvents used for membrane casting and the resultant morphology of the isoporous membranes. Polymer dispersions were either loaded in capillary tubes (1.5 mm diameter) or sandwiched between two Kapton films in a washer depending on the viscosity of the polymer solution. Membrane samples were mounted on hollow washers using double-sided Kapton tape such that the measurement area included the free-standing membrane. SAXS measurements were performed using beamline 7.3.3 at the Advanced Light Source (Berkeley, CA, USA) (Hexemer, A. et al. A SAXS/WAXS/GISAXS Beamline with Multilayer Monochromator. J. Phys. Conf. Ser. 2010, 247, 012007). During data collection, a Pilatus 2M detector was positioned approximately 3.5 m from the sample; exact distances were calibrated using silver behenate. The beam energy was 10 keV, and exposure times varied between 0.5 and 120 sec. The two-dimensional scattering images were radially averaged, using pyFAI (Ashiotis, G. et al. The Fast Azimuthal Integration Python Library: pyFAI. J. Appl. Crystallogr. 2015, 48 (2), 510-519) to generate one-dimensional profiles of the scattering intensity versus the scattering vector,

$$q = \frac{4 π}{λ} \times sin ( \frac{θ}{2} ) \qquad ( EQ . 2 )$$

where θ is the scattering angle and λ is the wavelength of the polarized X-ray (approximately 1.2 Å at 10 keV). SAXS profiles of polymer dispersions were normalized by subtracting the scattering intensity of empty capillary tubes or Kapton windows.

Tensile tests were performed on an Instron 34TM5 equipped with a 100 N load cell. Dense block copolymers and mesoporous membranes were punch-cut into dog bone-shaped specimens of 20 mm gauge length, L, 4 mm width, w, and ca. 10-50 μm thickness, t. This thickness corresponds to an average of three independent measurements on each specimen. The specimens were uniaxially stretched at an initial rate of 0.003 s⁻¹, and the measured force, F, was used to estimate the engineering stress, σ_{N}, according to,

$${σ}_{N} = \frac{F}{wt} \qquad ( EQ . 3 )$$

In addition, the measured displacement, L−L₀, was used to estimate the stretch, λ, according to:

$$λ = \frac{L}{{L}_{0}} \qquad ( EQ . 4 )$$

Three tensile curves were measured for each dense film or mesoporous membrane. These stress-stretch curves were used to evaluate (i) the elastic modulus, E, according to:

$${E = ( \frac{d {σ}_{N}}{d λ} ) \vert}_{λ = 1.005} \qquad ( EQ . 5 )$$

(ii) The tensile strength (i.e., stress at break), σ_{f}:

$${σ}_{f} = max ( {σ}_{N} ) \qquad ( EQ . 6 )$$

(iii) The stretch at break, λ_{f}:

$${λ}_{f} = max ( λ ) \qquad ( EQ . 7 )$$

(iv) and, finally, the work to fracture, W:

$$W ( {λ}_{f} ) = {\int }_{1}^{{λ}_{f}} {σ}_{N} ( λ ) d λ \qquad ( EQ . 8 )$$

The reported values and confidence intervals correspond to the average and the standard error of three independent measurements.

Contact angle was measured using a goniometer (ramé-hart, model 200-F1) according to the captive bubble method reported previously (Zhang, W. et al. Membrane Characterization by the Contact Angle Technique II. Characterization of UF-Membranes and Comparison between the Captive Bubble and Sessile Drop as Methods to Obtain Water Contact Angles). The membrane was clamped on the sample holder with its active side facing down. The sample holder was immersed in DI water, and a droplet of n-decane was attached to the membrane using a syringe (Cole-Parmer, Vernon Hills, Illinois) and a hooked-shaped needle. The contact angle was measured using DROPimage Advanced software.

To prepare samples for scanning electron microscopy (SEM), membranes were solvent-exchanged from water to a 50% v/v mixture of DI water and methanol for at least 2 hours. Samples of the top and bottom sides of the membrane were placed on SEM stems. Membrane cross-sections were prepared by soaking membranes in methanol for a few seconds before being immersed in liquid N₂ for at least 30 seconds and fractured with flat tweezers. After being sputter coated for 60 s at 40 mA with a 40:60 Au/Pt alloy source, all samples were imaged using an FEI Quanta 650 ESEM (10 kV, spot size of 3.0) at a working distance of 10 mm.

Cross-sectional SEM micrographs of mesoporous membranes were processed using an image segmentation protocol introduced by Bridge et al. (Bridge, A. T. et al. Rapid Macrovoid Characterization in Membranes Prepared via Nonsolvent-Induced Phase Separation: A Comparison between 2D and 3D Techniques. J. Membr. Sci. 2022, 661, 120923). Briefly, the micrographs were binarized (i.e., thresholded), and the macroporosity or macrovoid areal fraction, Dₘ, was estimated according to

$${D}_{m} = \frac{{N}_{0}}{{N}_{0} + {N}_{1}} \qquad ( EQ . 9 )$$

where N₀ and N₁ are the number of black (0) and white (1) pixels, respectively. This protocol was also used to estimate the surface porosity, pore size distribution, and pore density from surface SEMs. The surface porosity was estimated using Eq. 8 on a top surface instead of a cross-sectional image.

The pore density was estimated according to:

$$ρ = \frac{{C}_{pores}}{{A}_{surface}} \qquad ( EQ . 10 )$$

where Cₚₒᵣₑₛ is the total number of pores in an image, and A_{surface} is the area of the image. In this analysis, the pores were defined as discrete clusters of black pixels, as in Bridge et al. (Id.)

For calculating the pore size distribution, the diameter of each pore was estimated according to:

$$d = 2 \frac{\sqrt{{A}_{pore}}}{π} \qquad ( EQ . 11 )$$

where Aₚₒᵣₑ is the surface area of a pore. This calculation assumes the pores are circular, which is a reasonable assumption for mesoporous membranes. Averages and one standard deviation are reported for all values of triplicate images.

Dead end filtration cells from Advantec MFS (Dublin, CA) were used to measure the pure water permeance. Membrane samples with 2.5 cm diameter were cut from a cast membrane and loaded into the cell on top of a porous polypropylene support that had negligible resistance to water transport. The dead end cell was filled with DI water and pressurized with 5-60 psi nitrogen gas. The permeate was collected in a beaker on an electronic balance (Mettler Toledo, Columbus, OH). The permeate mass was automatically recorded as a function of time, and the slope of this data was determined to give the mass flow rate. Using the density of water and dividing by the sample area, the flux was calculated by converting the mass flow rate into a volumetric flow rate.

$$J = \frac{Δ V}{A Δ t} \qquad ( EQ . 12 )$$

The membrane permeance (P) was then calculated by dividing the flux by the transmembrane pressure (ΔP).

$$P = \frac{J}{Δ P} \qquad ( EQ . 13 )$$

Triplicate measurements were recorded at each pressure point. Hysteresis was observed on the first trial, as the higher pressures activated and wetted more of the pores, causing a rapid increase in the flux with pressure. Values were not recorded until a steady state permeance was established, which typically occurred after two to three trials.

The polymer supports used for supported ionic liquid membranes (SILMs) were asymmetric, meaning that tortuosity and porosity vary with depth, so each SILM was prepared with the same film orientation (i.e., skin layer side up). Ionic liquid (IL) was deposited on a support 0.5″ in diameter to completely cover the surface. For 1-hexyl-3-methylimidazolium bis(trifluoromethylsulfonyl) imide ([hmim][Tf₂N]) and trihexyltetradecylphosphonium trimethylphosphate ([P₂₂₂₈][TMPP]) SILMs, the ILs were allowed to soak into the supports for at least 24 h and 48 h, respectively, to ensure total wetting which was confirmed by IL pooling on the underside of the support. Excess IL was removed from the surface of the SILMs by patting dry with a Kimwipe. Using epoxy, the edge of the SILM was attached to the inner edge of a brass disc with a hole 0.375″ in diameter bored in the center such that the disc could be mounted inside a Millipore filter cell for gas permeation testing. Here, the skin layer of the support was oriented towards the feed side. The active area of the membrane was determined by scanning the resulting brass disc with the attached SILM using a CanoScan LiDE 400 scanner from Canon.

Gas transport through SILMs is reported in terms of permeance—rather than permeability—due to inherent uncertainty regarding the effective thickness of the trapped IL. The pure-gas permeances of carbon dioxide, propane, ethane, methane, and nitrogen were measured with three independent measurements for each IL using the constant-volume variable-pressure method. The permeation system used was custom designed in-house. All permeation experiments were conducted at 35° C., and SILM samples were degassed under technical vacuum for at least 12 h prior to each run. Then, one of the desired gases was introduced to the upstream side of the system and allowed to permeate through the membrane into an isolated volume initially under vacuum. After steady-state was achieved, the permeance (or pressure-normalized flux), P [cm³ (STP)· (cm²·s·cm Hg)⁻¹], was calculated as follows [4]:

$$P = \frac{{V}_{d}}{{p}_{2} ART} [ {( \frac{{dp}_{1}}{dt} )}_{ss} - {( \frac{{dp}_{1}}{dt} )}_{leak} ] \qquad ( EQ . 14 )$$

where V_{d} is the downstream volume (cm³), p₂ is the upstream absolute pressure (cm Hg), A is the film area available for gas transport (cm²), R is the gas constant [0.278 cm Hg·cm³·(cm³ (STP)·K)⁻¹], T is absolute temperature (K), (dp₁/dt)ₛₛ is the steady-state rate of pressure rise (cm Hg·s⁻¹) in the downstream volume at fixed upstream pressure, and (dp₁/dt)ₗₑₐₖ is the steady-state rate of pressure rise (cm Hg·s⁻¹) in the downstream volume when isolated. Here, we report permeance in units of GPU, with 1 GPU=10⁻⁶ cm³ (STP)·(cm²·s·cm Hg)⁻¹.

Blowout is characterized by a sudden increase in gas permeance by several orders of magnitude and loss of selectivity caused by the expulsion of IL from the pores of the support membrane. The blowout pressure of SILMs was determined using a constant-volume variable-pressure permeation system. Samples were prepared using the previously described procedure and subjected to N₂ permeation tests. The pressure on the upstream side of the membrane was gradually increased in increments of 0.1-0.5 bar, depending on the sample, and each pressure step was held for at least 30 minutes to ensure SILM stability. This process was continued until the SILM experienced blowout. In this study, the blowout pressure was taken as the first pressure step where the N₂ permeance was observed to be more than three standard deviations greater than the average initial N₂ permeance of the SILMs. These tests were carried out 5 times for each sample, and variance is assumed to be normally distributed.

### Example 1: Synthesis and Fabrication of Mechanically Robust and Mesoporous SISV Tetrablock Polymer Membranes for Ultrafiltration

Membrane-based separations offer substantial environmental, economic, and safety benefits over traditional separation methods that require phase changes (Baker, R. W. Membrane Technology and Applications, 3rd ed.; John Wiley and Sons Ltd, 2012). Over the past few decades, significant advances in the field of membrane science have enabled enhanced separations for water purification (Madhura, L. et al. Membrane Technology for Water Purification. Environ. Chem. Lett. 2018, 16 (2), 343-365), bio-separations (Zydney, A. L. Membrane Technology for Purification of Therapeutic Proteins. Biotechnol. Bioeng. 2009, 103 (2), 227-230), and other industrial processes (Galambos, I. et al. High Organic Content Industrial Wastewater Treatment by Membrane Filtration. Desalination 2004, 162, 117-120; Chen, G. Q. et al. Membrane Separations in the Dairy Industry. In Separation of Functional Molecules in Food by Membrane Technology; Elsevier, 2019; pp 267-304). Isoporous membranes with a high density of uniform surface pores represent a desirable material platform for ultrafiltration membranes because they overcome the pernicious tradeoff between permeability and selectivity typically seen for phase inversion membranes with similar average pore diameters (Werber, J. R. et al. Materials for Next-Generation Desalination and Water Purification Membranes. Nat. Rev. Mater. 2016, 1 (5), 16018; Hampu, N. et al. Next-Generation Ultrafiltration Membranes Enabled by Block Polymers. ACS Nano 2020, 14 (12), 16446-16471; Guillen, G. R. et al. Preparation and Characterization of Membranes Formed by Nonsolvent Induced Phase Separation: A Review. Ind. Eng. Chem. Res. 2011, 50 (7), 3798-3817; Mehta, A. et al. Permeability and Selectivity Analysis for Ultrafiltration Membranes. J. Membr. Sci. 2005, 249 (1-2), 245-2497). With uniform, narrow pore distributions, these membranes have been shown to have precise molecular weight cut-offs while operating at higher permeate fluxes than more traditional membranes (Hampu, et al. Id.).

One of the most promising routes for producing isoporous membranes is self-assembly and nonsolvent-induced phase separation (SNIPS). This method involves casting a solution of an amphiphilic polymer in a solvent blend that has more favorable interactions with one of the blocks over the other, optimizing micelle formation in solution (Dorin, R. M. et al. Solution Small-Angle X-Ray Scattering as a Screening and Predictive Tool in the Fabrication of Asymmetric Block Copolymer Membranes. ACS Macro Lett. 2012, 1 (5), 614-617; Peinemann, K.-V. et al. Asymmetric Superstructure Formed in a Block Copolymer via Phase Separation. Nat. Mater. 2007, 6 (12), 992-996). After a dry step time where the cast solution is allowed to sit in air, the film is submerged in a nonsolvent (typically water) bath, vitrifying the polymer as the solvent and nonsolvent exchange. The mechanism through which this highly non-equilibrium process occurs is still debated; however, several key parameters such as polymer architecture and relative block sizes, solvent composition, polymer concentration, polymer-solvent interactions, dry step time, relative humidity, temperature, and nonsolvent identity all control the final membrane morphology (Hahn, J. et al. Thin Isoporous Block Copolymer Membranes: It Is All about the Process. ACS Appl. Mater. Interfaces 2015, 7 (38), 21130-21137; Oss-Ronen, L. et al. Characterization of Block Copolymer Self-Assembly: From Solution to Nanoporous Membranes. Macromolecules 2012, 45 (24), 9631-9642; Müller, M. et al. Nonequilibrium Processes in Polymer Membrane Formation: Theory and Experiment. Chem. Rev. 2021, 121 (22), 14189-14231). This technique is similar to membrane fabrication via nonsolvent-induced phase separation (NIPS) of homopolymers that are incapable of block copolymer self-assembly; however, the resulting membranes typically have wider pore size distributions (Mehta, A. et al. Permeability and Selectivity Analysis for Ultrafiltration Membranes. J. Membr. Sci. 2005, 249 (1-2), 245-249).

Since the first report of SNIPS as a method for producing asymmetric membranes in 2007 (Peinemann, et al., Id.), significant research efforts have focused on tuning the structure of the resultant membranes. Abetz, Nunes, and Peinemann have all worked on developing the techniques necessary to form hollow fiber membranes from polymers that have formed isoporous, flat sheet membranes (Hilke, R. et al. Block Copolymer/Homopolymer Dual-Layer Hollow Fiber Membranes. J. Membr. Sci. 2014, 472, 39-44; Noor, N. et al. A Facile Method to Prepare Double-Layer Isoporous Hollow Fiber Membrane by In situ Hydrogen Bond Formation in the Spinning Line. Macromol. Rapid Commun. 2016, 37 (5), 414-419; Radjabian, M. et al. Tailoring the Morphology of Self-Assembled Block Copolymer Hollow Fiber Membranes. Polymer 2014, 55 (13), 2986-2997; Sankhala, K. et al. A Pathway to Fabricate Hollow Fiber Membranes with Isoporous Inner Surface. Adv. Mater. Interfaces 2017, 4 (7), 1600991; Sankhala, K. et al. Setting the Stage for Fabrication of Self-Assembled Structures in Compact Geometries: Inside-Out Isoporous Hollow Fiber Membranes. ACS Macro Lett. 2018, 7 (7), 840-845). These groups have also shown isoporous membranes can be fabricated with pore sizes in the sub 10 nm range, allowing for unprecedented separation of particles with similar dimensions. Zhang et al. designed and synthesized a triblock polymer with multifunctional pore walls that was able to discriminate between charged and uncharged molecules with diameters between 1-2 nm (Zhang, Z. et al. Chemically Tailored Multifunctional Asymmetric Isoporous Triblock Terpolymer Membranes for Selective Transport. Adv. Mater. 2020, 32 (8), 1907014). Yu et al. utilized electroless gold deposition on isoporous membranes to precisely control the diameter of their isoporous membranes, leading to well-controlled size discrimination with pore diameters as low as 3.5 nm (Yu, H. et al. Self-Assembled Isoporous Block Copolymer Membranes with Tuned Pore Sizes. Angew. Chem. Int. Ed. 2014, 53 (38), 10072-10076). Many of the polymers most compatible with SNIPS processing utilize a polystyrene (PS) hydrophobic block with a hydrophilic block such as poly(4-vinylpyridine) (P4VP) (Phillip, W. A. et al. Tuning Structure and Properties of Graded Triblock Terpolymer-Based Mesoporous and Hybrid Films. Nano Lett. 2011, 11 (7), 2892-2900; Saleem, S. et al. Isoporous Membranes from Polystyrene-b-Poly(4-Vinylpyridine)-b-Poly(Solketal Methacrylate) (PS-b-P4VP-b-PSMA) Triblock Terpolymers and Their Post-Modification. Polymers 2019, 12 (1), 41; Shevate, R. et al. Polydopamine/Cysteine Surface Modified Isoporous Membranes with Self-Cleaning Properties. J. Membr. Sci. 2017, 529, 185-194; Höhme, C. et al. Postfunctionalization of Nanoporous Block Copolymer Membranes via Click Reaction on Polydopamine for Liquid Phase Separation. ACS Appl. Nano Mater. 2018, 1 (7), 3124-3136), poly(2-vinylpyridine) (P2VP) (Jung, A. et al. Structure Formation of Integral Asymmetric Composite Membranes of Polystyrene-Block-Poly(2-Vinylpyridine) on a Nonwoven: Structure Formation of Integral Asymmetric Composite Membranes. Macromol. Mater. Eng. 2012, 297 (8), 790-798), poly(ethylene oxide) (PEO) (Hahn, J. et al. Structure Formation of Integral-Asymmetric Membranes of Polystyrene-Block-Pol y (Ethylene Oxide). J. Polym. Sci. Part B Polym. Phys. 2013, 51 (4), 281-290; Karunakaran, M. Isoporous PS-b-PEO Ultrafiltration Membranes via Self-Assembly and Water-Induced Phase Separation. J. Membr. Sci. 2014, 7), poly(acrylic acid) (PAA) (Mulvenna, R. A. et al. Tunable Nanoporous Membranes with Chemically-Tailored Pore Walls from Triblock Polymer Templates. J. Membr. Sci. 2014, 470, 246-256; Weidman, J. L. et al. Nanostructured Membranes from Triblock Polymer Precursors as High Capacity Copper Adsorbents. Langmuir 2015, 31 (40), 11113-11123; Weidman, J. L. et al. Unusually Stable Hysteresis in the PH-Response of Poly(Acrylic Acid) Brushes Confined within Nanoporous Block Polymer Thin Films. J. Am. Chem. Soc. 2016, 138 (22), 7030-7039), or other hydrophilic polymers (Schöttner, S. et al. Amine-Containing Block Copolymers for the Bottom-Up Preparation of Functional Porous Membranes. Macromolecules 2019, 52 (7), 2631-2641). Despite the wide variety of hydrophilic polymers that could be used, P4VP has become the most common hydrophilic block because the large Flory-Huggins interaction parameter between it and polystyrene leads to more facile membrane fabrication. One of the major drawbacks of isoporous membranes made via SNIPS has been their lack of mechanical integrity under an applied stress. Because the hydrophobic block of the amphiphilic block copolymer (BCP) forms the structural matrix of the membrane, homopolymer PS is an unideal polymer for this role. PS is a glassy polymer of high packing length and entanglement molecular weight and is therefore inherently brittle. Casting the membranes onto a woven support can help alleviate some of the mechanical issues, yet the excessive brittleness PS still leads to cracking and breaking at transmembrane pressures relevant for ultrafiltration.

Philip et al. have demonstrated that the addition of a polyisoprene (PI) block on the hydrophobic terminus of the BCP lead to modest improvements to the overall flexibility and toughness of isoporous membranes (Phillip, et al., Id.; Weidman, et al., 2016, Id.). Previous work improved upon their polymer design by placing a rubbery poly(ethylene-alt-propylene) block in the middle of two polystyrene domains, creating an architecture similar to high impact polystyrene for the structural matrix. This design improved the flexibility and toughness of the resulting membranes, which enabled free-standing membranes to withstand greater transmembrane pressures in testing. Whereas a PS-P4VP polymer with a total molecular weight below 100 kg/mol forms a brittle membrane that requires a support structure to withstand low pressure testing, freestanding membranes made with a similar molecular weight polymer were durable enough for permeation testing at 4.0 bar of transmembrane pressure. This work relied upon a hydrophilic PEO block as the pore-forming block, which has relatively favorable interactions with PS compared to P4VP. The weak segregation strength between the hydrophilic and hydrophobic blocks made micelle formation and ordering more difficult than in a system with stronger differences in compatibility between the blocks and between each block and the solvent, making it harder to make isoporous membranes.

This study created tough, isoporous membranes using a PS-PI-PS-P4VP (SISV) tetrablock polymer that exceed the superior mechanical properties of prior work. This polymer is substantially easier to fabricate into isoporous membranes compared to the tetrablock polymer that used poly(ethylene oxide) as the hydrophilic block. Optimization of the polymer concentration, dry step time, and additives facilitated the production of asymmetric, flat sheet membranes large enough for permeation and mechanical testing. Functionalization of the pore walls via quaternization of the P4VP block has been demonstrated in the literature and can also be achieved using this material (Qiu, X. et al. Selective Separation of Similarly Sized Proteins with Tunable Nanoporous Block Copolymer Membranes. ACS Nano 2013, 7 (1), 768-776; Zhang, Z. et al. Quaternization of a Polystyrene-Block-poly(4-vinylpyridine) Isoporous Membrane: An Approach to Tune the Pore Size and the Charge Density. Macromol. Rapid Commun. 2019, 40 (3), 1800729). These modifications can cause the pore walls to swell, shrinking the effective diameter of the pore and lowering the molecular weight cutoff of the membrane. These results indicate that the commonly used PS-P4VP polymer can be improved upon by toughening the matrix forming block by adding a rubbery domain in the middle of the two polystyrene domains, ultimately yielding a stand-alone polymer membrane capable of operating at higher transmembrane pressures than is typically seen in the PS-P4VP literature.

### Materials and Methods

Synthesis of SISV Polymer: The poly(styrene-b-isoprene-b-styrene-b-(4-vinylpyridine)) (SISV) tetrablock polymer was synthesized via sequential anionic polymerization. All monomers were purified using standard laboratory drying methods. In each case, the desiccant was added to the monomer in a purification vessel that was then subjected to at least three freeze-pump-thaw cycles using liquid nitrogen to remove oxygen and vacuum transferred to either a secondary purification vessel with another desiccant or a flame-dried monomer buret. Styrene (65 mL) was first distilled over calcium hydride (CaH₂) followed by dibutylmagnesium (Bu₂Mg); isoprene (50 mL) was first distilled over CaH₂ followed by Bu₂Mg; 4-vinylpyridine (15.3 mL) was distilled over CaH₂ and distilled into a buret containing ca. 100 mL of distilled THF; and 1,1-diphenylethylene (3 mL) was distilled over Bu₂Mg. All of the monomer burets were then attached to a custom two liter, eight-necked, thick-walled glass reactor fitted with ACE-threads and equipped with a glass-coated stir bar. Two burets containing anhydrous cyclohexane (ca. 800 mL) and one buret containing ca. 400 mL of THF were also fitted to the reactor. Lastly, a glass vacuum line connector sealed with a 6 mm puresep septum was fitted to the reactor and attached to a Schlenk line via a flexible Swagelok connector. The entire reactor assembly was then placed under vacuum and flame dried. Upon cooling, the reactor was cycled with nitrogen and vacuum four additional times. The two burets of cyclohexane were then emptied to the reactor. With stirring, sec-butyllithium (690 μL, 0.966 mmol) was then added through the septa via a gastight syringe. 18.65 mL of the distilled styrene was then added to the reactor, at which point the solution turned bright orange, indicating the presence of the styryllithium anion. The reaction was then heated to 40° C. and allowed to stir overnight. The next morning, 24.5 mL of isoprene was added to the reactor, causing the color of the solution to turn to a pale yellow. 24 h later, a second addition of 18.65 mL of the styrene was added, causing the reaction to become bright orange. After an additional 24 h, the 1,1-diphenylethylene was added to the reaction, causing it to turn deep red. The cyclohexane was then removed under reduced pressure until the remaining red polymer was nearly completely dry. The polymer was then resuspended in THF from the buret attached to the reactor, at which point the entire reactor was cooled to −78° F. using a dry ice and acetone bath. The buret containing 4-vinylpyridine and THF was also cooled using powdered dry ice. After the reactor and buret had been given 20 minutes to cool, the 4-vinylpyridine was added to the reactor, causing the color to shift from bright red to dark orange. The 4-vinylpyridine block was given 2 h to grow, after which the reaction was terminated with degassed methanol. The polymer was then precipitated in methanol, filtered, and dried overnight under reduced pressure. Mn was determined by ¹H NMR and SEC analysis. Ð(M_{w}/Mₙ) values, relative to polystyrene standards, were determined by SEC. TABLE 12 contains a summary of the characterization of the materials synthesized for this study.

TABLE 12
Molecular weight and mass fraction of the block
copolymers used in this study. Values were determined
using end group analysis of ¹H NMR spectra.

| Polymer | Mₙ (kg/mol) | wt % PS | wt % PI | wt % P4VP |
|---|---|---|---|---|
| SISV17 | 107.0 | 57.5 | 25.7 | 16.8 |
| SISV18 | 66.1 | 54.9 | 27.4 | 17.7 |
| SISV19 | 74.4 | 54.7 | 26.7 | 18.5 |
| SISV20 | 82.5 | 54.9 | 25.0 | 20.1 |
| SISV29 | 101.8 | 49.7 | 21.6 | 28.6 |

Casting of SISV Isoporous Membranes: The polymer (SISV18) is then dissolved into a 70/30 w/w solution of 1,4-dioxane/tetrahydrofuran with 0.15 wt % copper bis(trifluoromethylsulfonyl) imide. This polymer casting solution is then spread on a glass plate at a thickness 200 μm where the solvent is then allowed to evaporate for 30 seconds which causes the solution to self-assemble. Next, the membrane is immersed into a water bath which causes the polymer to vitrify and locks in the isoporous structure achieved during the dry step.

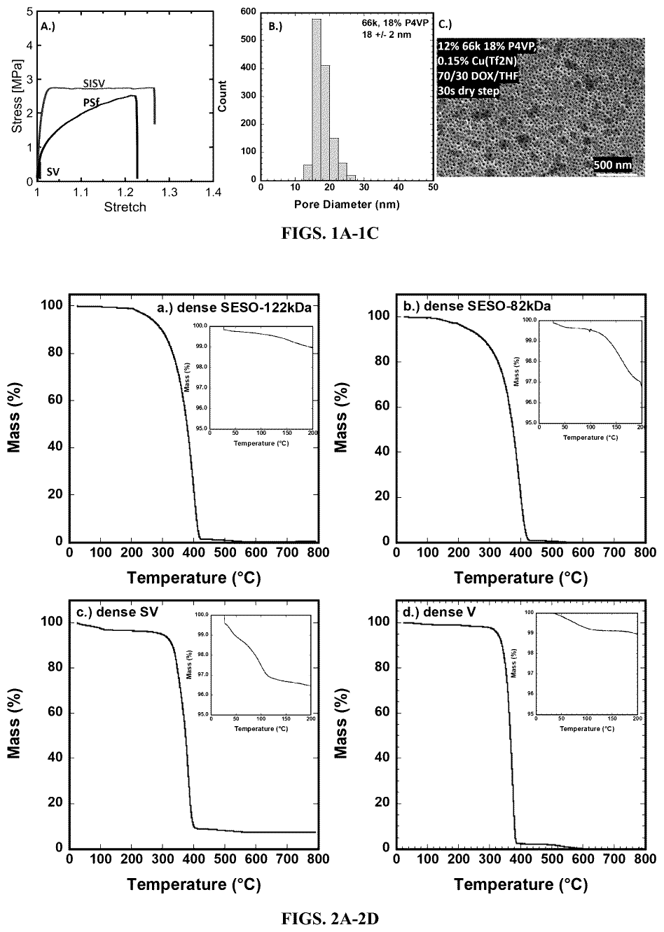

Mechanical testing data of the membranes is shown in FIGS. 1A-1C.

There are two features that are different in these membranes. The first is the tetrablock polymer design. The diblock (SV) is commonly used, and work has been done on the triblock ISV. However, no work in the open literature demonstrates that a tetrablock (SISV) can make isoporous membranes. Using this tetrablock architecture gives significant improvements in mechanical properties. The diblock has a strain energy density of 3 KJ/m³, while the toughness of the tetrablock is two orders of magnitude higher.

Polymer Dope Casting Solution Preparation: To prepare casting solutions for SNIPS, target quantities of each solvent were mixed in a 20 mL scintillation vial that had been purged with dry nitrogen to remove any dust. To minimize evaporative losses, solvents were added in order of decreasing boiling point. The desired quantities of polymer were then weighed and added to the solvent mixture. Viscous solutions were left to rotate on a heated roller for at least two days prior to membrane fabrication to prepare visually homogenous casting solutions. Non-viscous solutions were mixed on a stir plate for at least two days before casting.

Asymmetric Membrane Preparation by Self-Assembly and Nonsolvent Induced Phase Separation (SNIPS): Each solution was poured onto a cleaned glass plate, after which a 4-inch Gardco doctor blade was used to meter the solution to a uniform thickness of 200 μm for all membranes. The cast solution was left in ambient air at ˜23° C. and 50-55% relative humidity (unless specified otherwise) for 5-60 s to undergo the evaporation step of the membrane formation process. After evaporation, the cast solution was immersed in a ˜23° C. DI water bath to undergo wet phase inversion and complete the membrane formation process. The resulting membranes were left to soak in a beaker filled with DI water for 24 h to leach out residual solvent, then solvent exchanged for at least 2 h in a 50/50 (by volume) mixture of deionized water and methanol.

### Results and Discussion

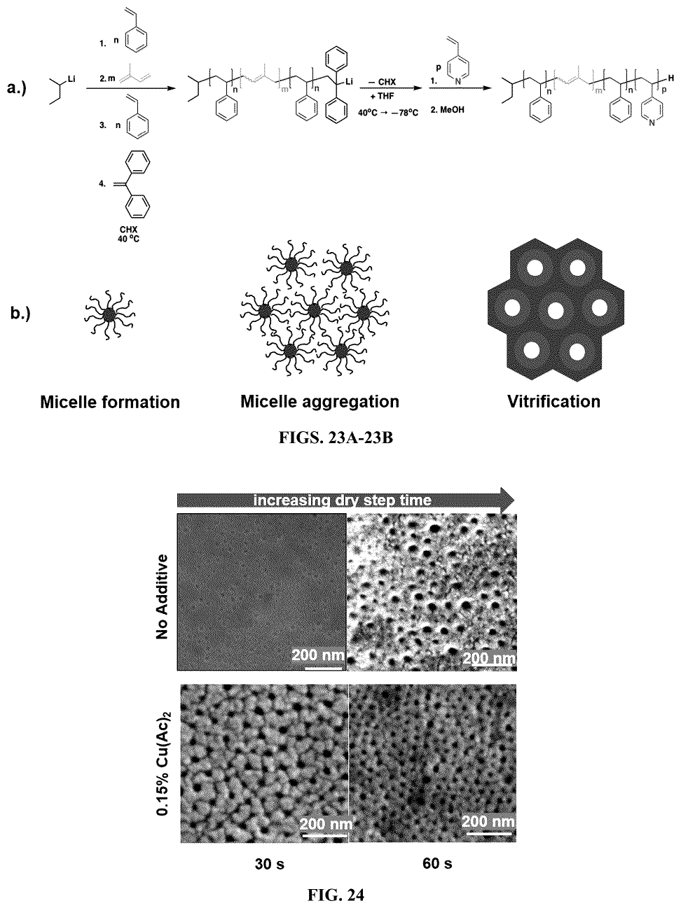

Tetrablock Design Choice: The SISV polymer utilized in this work was synthesized via sequential anionic polymerization initiated from sec-butyllithium (see Example 1). The SIS architecture within the tetrablock that forms the structural matrix of the membrane has been previously shown to increase the mechanical toughness when compared to both diblock (i.e. PS-P4VP) and triblock (i.e., PI-PS-P4VP and PI-PS-PAA) architectures (Phillip et al., Id.). FIGS. 23A-23B detail the synthesis of the tetrablock. Optimization of the polymerization procedure was nontrivial. One issue was to determine the best way to rigorously dry the monomers and solvents used in the polymerization. Anionic polymerization was the desired polymerization method because it can be scaled reasonably easily to the batch sizes required for SNIPS. Extreme care must be given to remove as much water and impurities as possible from the monomers because the reactions are very sensitive to water. Optimizing the purification process involved optimizing the most suitable desiccants (i.e. calcium hydride, di-n-butylmagnesium, butylmagnesium chloride, ethylaluminum dichloride) for the correct amounts of time and for the correct sequences of freeze-pump-thawing and distilling. The other issue lies in the differences in reactivity and polarity of the monomers. Styrene and isoprene polymerize well in cyclohexane at 40° C.; however, 4-vinylpyridine is too reactive to polymerize in a controlled manner at these conditions and the resultant P4VP is not soluble in cyclohexane. The polymerization could theoretically be conducted in THF at low temperatures to avoid lithium carbanion ring-opening of the THF solvent; however, isoprene polymerizes very slowly at low temperature and the 3,4 isomer is favored at these temperatures whereas the 1,4 isomer is the desired isomer for the polymer. Other polar aprotic solvents such as anisole were investigated; however, these solvents were not suitable for the polymerization.

The final reaction conditions used for synthesizing the SISV tetrablock polymer are adapted from previous reports (FIGS. 23A-23B) (Phillip, et al. Id.; Dorin, R. M. et al. Designing Block Copolymer Architectures for Targeted Membrane Performance. Polymer 2014, 55 (1), 347-353). The PS-PI-PS portion of the synthesis was carried out in cyclohexane at 40° C., which is typical for anionic polymerizations of these monomers. After the first three blocks of the polymer had been synthesized, the living alkyl lithium end group was capped with a single unit of 1,1-diphenylethylene to decrease the reactivity of the living anion. Following this addition, the cyclohexane was carefully removed from the reactor via vacuum distillation, after which the nearly dry polymer was redissolved in rigorously dried THF. The reactor and a buret of 4-vinylpyridine in THF (15 wt % 4VP) were then cooled in a dry ice/isopropanol bath and with crushed dry ice, respectively. The polymerization of the final block was run at −78° C. for 3.5 hours to allow for the complete consumption of the 4-vinylpyridine, after which the reaction was terminated with degassed methanol and allowed to warm to room temperature. Over the course of the polymerization, the color of the reaction can be used to determine if the reaction is still alive and what monomers are currently at the reaction propagation center.

The choice of block sizes was based on both the studies by Philip et al. and previous work (Phillip, et al., Id.). Smaller pores are more easily achieved when the starting BCP is small, and therefore it is important to utilize the lowest molecular weight polymer that still forms a robust membrane. SNIPS membranes have been fabricated from polymers with hydrophilic blocks typically between 12-30% by weight (Rangou, S. et al. Self-Organized Isoporous Membranes with Tailored Pore Sizes. J. Membr. Sci. 2014, 451, 266-275). The relative block sizes can affect both solution ordering and final morphology, so it is important to study how a change in relative block size can affect the process. For these reasons, a variety of molecular weights and weight fractions of P4VP were synthesized.

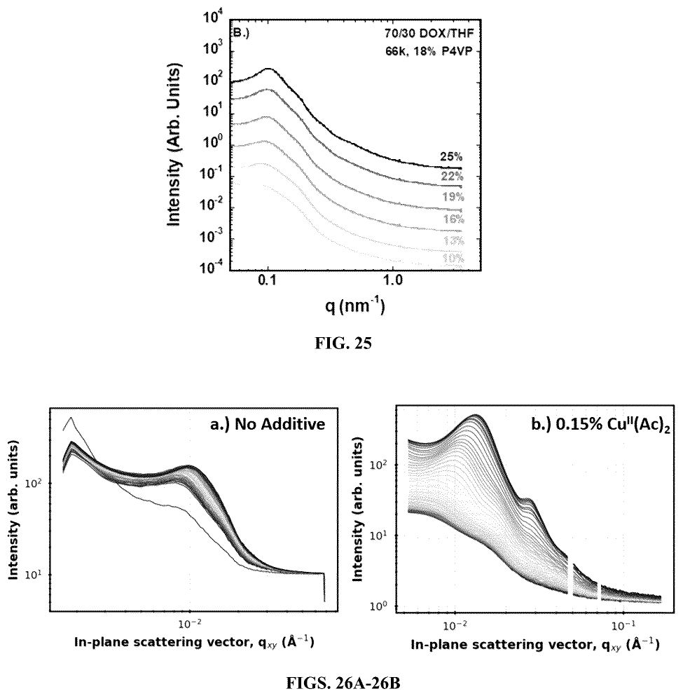

Optimization of Casting Conditions: An additional method for producing isoporous membranes is through the addition of organic-soluble metal salts such as copper acetate, magnesium acetate, and aluminum acetate (Nunes, S. P. et al. Ultraporous Films with Uniform Nanochannels by Block Copolymer Micelles Assembly. Macromolecules 2010, 43 (19), 8079-8085). The P4VP block can coordinate tightly to these ions in solution via the nitrogen atom of the pyridine ring, which can bring these blocks together and help drive their segregation from the hydrophobic blocks in the casting solution. SEM's of the top surface are shown below in FIG. 24 and FIG. 25.

Understanding the Formation Mechanism through in situ GISAXS Study: FIGS. 26A-26B shows in situ GISAXS data.

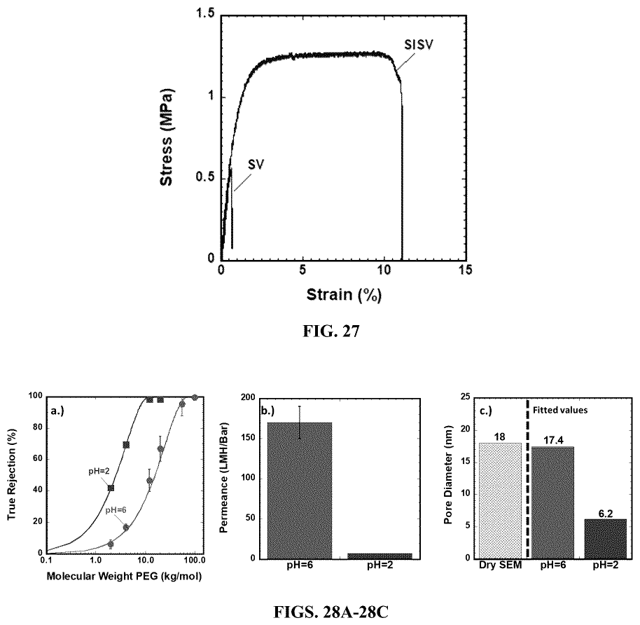

Characterization of Membrane Performance: To quantify the relative toughness of these materials, tensile testing of dense films and asymmetric membranes of the tetrablock and the SV polymer was conducted (FIG. 27). For the dense films, the SISV and SV had similar maximum stresses; however, the SISV polymer had a larger strain energy density and was therefore tougher. The overall stresses the asymmetric membranes could tolerate was lower than for the dense films. The SV polymer was able to withstand the least stress and cracked after slight deformation. The SISV polymer was able to withstand significantly higher stress and exhibited more yielding, giving it significantly higher strain energy density. FIGS. 28A-28C show time rejection, permeance, and pore diameter.

### Conclusion

A SISV tetrablock polymer was synthesized and cast into mesoporous membranes with pore sizes in the ultrafiltration regime. Significant synthetic challenges existed for this polymer; however, many of the reaction conditions were carefully optimized to make the polymerization repeatable and easily scaled. A solvent swap midway through the reaction was the key step for polymerizing a final, significantly more polar block. Although further optimization is needed to achieve a perfectly isoporous surface, these asymmetric membranes have vastly superior mechanical strength compared to PS-P4VP diblock polymers as well as industrially used polysulfone membranes cast at similar polymer concentrations.

This technology will create isoporous membranes that are tough and able to operate for longer times at higher transmembrane pressures than current isoporous membranes.

These isoporous membranes can be used to make supported ionic liquid membranes (SILMs) where an ionic liquid is impregnated in the isoporous membrane. The ionic liquid can have unique separation properties, such as outstanding olefin/paraffin separation properties or a high affinity for CO₂ for use in direct air capture membrane systems. Because the pore sizes are all the same size, the SILM is much more stable to higher transmembrane pressures than SILMs produced using commercial porous membranes, which have a very broad pore size distribution.

### Example 2: Synthesis and Fabrication of Mechanically Robust and Mesoporous SESO Tetrablock Polymer Membranes for Ultrafiltration

This example synthesized an ABAC tetrablock copolymer, poly(styrene-b-(ethylene-alt-propylene)-b-styrene-b-ethylene oxide) (SESO), placing a rubbery block in the middle of the matrix-forming hydrophobic block. The rubbery block added compliance to the structural hydrophobic matrix and markedly enhanced the toughness. Poly(ethylene oxide) (PEO) was chosen as the hydrophilic block because of its low propensity for fouling in the presence of proteins, viruses, and other organic matter (Kang, G.; Yu, H.; Liu, Z.; Cao, Y. Surface Modification of a Commercial Thin Film Composite Polyamide Reverse Osmosis Membrane by Carbodiimide-Induced Grafting with Poly(Ethylene Glycol) Derivatives. Desalination 2011, 275 (1-3), 252-259; Ju, H. et al. Preparation and Characterization of Crosslinked Poly(Ethylene Glycol) Diacrylate Hydrogels as Fouling-Resistant Membrane Coating Materials. J. Membr. Sci. 2009, 330 (1-2), 180-188; Mao, H. et al. Control of Pore Hydrophilicity in Ordered Nanoporous Polystyrene Using an AB/AC Block Copolymer Blending Strategy. Faraday Discuss. 2005, 128, 149). Additionally, variants of PEO can be synthesized by copolymerizing ethylene oxide with allyl glycidyl ether or epichlorohydrin and leveraging thiol-ene click chemistry or nucleophilic substitutions to functionalize the pore wall and tailor the bulk transport properties (Dimitriou, M. D. et al. A General Approach to Controlling the Surface Composition of Poly(Ethylene Oxide)-Based Block Copolymers for Antifouling Coatings. Langmuir 2011, 27 (22), 13762-13772; Shukla, G. et al. The Versatile, Functional Polyether, Polyepichlorohydrin: History, Synthesis, and Applications. J. Polym. Sci. 2021, 59 (22), 2704-2718; Oleske, K. W. et al. Block Copolymer Directed Nanostructured Surfaces as Templates for Confined Surface Reactions. Macromolecules 2017, 50 (2), 542-549). Processing this tetrablock copolymer by SNIPS led to mesoporous membranes with an average surface pore diameter of 24±4 nm. These membranes were tested in uniaxial elongation until failure and pressurized with pure water feeds of up to 4.0 bar, a transmembrane pressure considerably higher than the 0.1-2.0 bar of transmembrane pressure typically used to characterize brittle SV membranes (Qiu, X. et al. Selective Separation of Similarly Sized Proteins with Tunable Nanoporous Block Copolymer Membranes. ACS Nano 2013, 7 (1), 768-776; Yu, H. et al. Self-Assembled Isoporous Block Copolymer Membranes with Tuned Pore Sizes. Angew. Chem. Int. Ed. 2014, 53 (38), 10072-10076; Zhang, Z. et al. Quaternization of a Polystyrene-Block-poly(4-vinylpyridine) Isoporous Membrane: An Approach to Tune the Pore Size and the Charge Density. Macromol. Rapid Commun. 2019, 40 (3), 1800729; Zhang, Z. et al. Chemically Tailored Multifunctional Asymmetric Isoporous Triblock Terpolymer Membranes for Selective Transport. Adv. Mater. 2020, 32 (8), 1907014). The results illustrate the benefits of incorporating rubbery domains within glassy polymers for co-designing the mechanical and transport properties of mesoporous membranes.

SIS-OH synthesis: The SIS-OH triblock was synthesized using sequential anionic polymerization initiated with sec-butyllithium following previously reported procedures (Ndoni, S. et al. Laboratory-scale Setup for Anionic Polymerization under Inert Atmosphere. Rev. Sci. Instrum. 1995, 66 (2), 1090-1095; Hillmyer, M. A. et al. Synthesis and Characterization of Model Polyalkane-Poly(Ethylene Oxide) Block Copolymers. Macromolecules 1996, 29 (22), 6994-7002). Before setting up the reactor, styrene (48 mL, 0.419 mol) was stirred over dibutyl magnesium, freeze-pump-thawed three times, and then distilled. Isoprene (24.1 mL, 0.241 mol) was stirred over calcium hydride, freeze-pump-thawed, and distilled. Then, these steps were repeated using dibutyl magnesium instead of calcium hydride as the drying agent. Both monomers were kept in flame-dried burets, which were then attached to a custom two-liter, seven-necked, thick-walled glass reactor fitted with ACE-threads and equipped with a glass-coated stir bar. Two burets containing anhydrous cyclohexane were also fitted to the reactor. An excess of ethylene oxide (8.68 g, 0.197 mol) was condensed, freeze-pump-thawed three times, and distilled into a buret stored on ice and attached to the reactor with a flexible connector (Larson Electric Glass). Finally, a glass vacuum line connector sealed with a 6 mm puresep septum was fitted to the reactor and attached to a Schlenk line with a flexible Swagelok connector. The remaining ports were plugged with Teflon stoppers, and the assembly was placed under vacuum and flame dried. The vessel was then backfilled with nitrogen to 5 psig and cycled through vacuum and nitrogen four more times. The reactor was charged with a positive gauge pressure nitrogen atmosphere, and 500 mL of cyclohexane were added to the reactor, followed by the sec-butyllithium initiator (536 μL, 0.75 mmol). Half of the distilled styrene was added to the reactor, at which point the solution turned bright orange, indicating the presence of styryllithium anions. The reaction was then heated to 40° C. and allowed to react overnight. The following day, isoprene was added to the reactor, changing the color of the solution to pale yellow. After eight hours, the second half of the styrene was added and allowed to react overnight. The following day, ethylene oxide was added to the reaction vessel, quenching the bright orange color and yielding a clear solution. The end-capping reaction was then allowed to proceed for one day, after which it was terminated with degassed isopropyl alcohol. The number-average molecular weight Mₙ was determined by 1H NMR and SEC analysis. The dispersity Ð(M_{w}/Mₙ), relative to polystyrene standards, was determined by size exclusion chromatography (SEC): Mₙ=71.8 kDa PS, 26.4 kDa PI; Ð=1.06. ¹H NMR spectroscopy (400 MHZ, CDCl₃) δ:6.33-7.37 (m, 3449H, aromatic H), 4.96-5.21 (m, 290H, 1,4-addition PI alkene), 4.59-4.84 (m, 195H, 3,4-addition PI alkene), 1.24-216 (4845, m alkane backbone), 0.55-0.78 (t, 6H, sec-butyl end group).

Hydrogenation of PI midblock reaction: The polyisoprene midblock was hydrogenated according to a previously reported procedure (Tureau, M. S.; Epps, T. H. Effect of Partial Hydrogenation on the Phase Behavior of Poly(Isoprene-b-Styrene-b-Methyl Methacrylate) Triblock Copolymers. Macromolecules 2012, 45 (20), 8347-8355). Briefly, 23.98 g of SIS-OH (94.6 mmol isoprene units, 1 eq.) and 71.0 g of 4-methylbenzenesulphonylhydrazide (381 mmol, 4 eq. per isoprene unit) were placed in a three-neck reactor and dissolved in 900 mL of anhydrous toluene. The two outer necks were each sealed with a septum secured with copper wire. The middle port was fitted with a reflux condenser capped with a septum with a needle outlet, after which the entire reactor was purged with nitrogen for 20 minutes. The reactor was then placed in an oil bath and heated to 120° C. overnight. The following day, the reaction mixture was cooled to room temperature and precipitated into 2 liters of methanol. The solid polymer was collected via filtration and dried in vacuo overnight. The conversion of the isoprene units to ethylene-alt-propylene (PEP) units was 95%, based on ¹H NMR spectroscopy. ¹H NMR spectroscopy (400 MHz, CDCl₃) δ:6.33-7.37 (m, 3449H, aromatic H), 4.96-5.21 (m, 22H, 1,4-PBD), 4.59-4.84 (m, 1H, 3,4-PBD), 1.24-216 (6051, m alkane backbone).

SESO synthesis via chain extension: The chain extension of SES-OH with ethylene oxide (EO) was done in a custom five-necked, thick-walled glass reactor fitted with ACE threads and equipped with a glass-coated stir bar. EO (4.91 grams, 111 mmol) was condensed, freeze-pump-thawed, and distilled into a buret, then sealed and stored on ice. SES-OH (17.73 g, 0.241 mmol) was then added to the reactor as a powder. The ports of the reactor were fitted with a buret containing anhydrous THF (300 mL), Teflon stoppers, a connecting port for the vacuum line with an additional port sealed with a 6 mm puresep septum, and the EO buret (via a flexible metal/glass union connector). The reactor was then placed under vacuum, flame dried, and purged with nitrogen to a pressure of 5 psig. The vacuum/purge cycle was conducted four more times, after which the THF was added to the reactor. The SES-OH powder was given one hour to dissolve fully. At that point, it was titrated with potassium naphthalenide (0.3 M in THF) until a light green coloration persisted, indicating complete conversion of the terminal alcohols to the corresponding potassium alkoxides. The EO was then added to the reactor by opening and inverting the buret, allowing the ethylene oxide to flow into the reactor through the flexible connector. Upon the addition of EO, the reaction color changed from light green to clear. The reaction mixture was allowed to stir for four days at 40° C. and was terminated with degassed methanol and evaporated to dryness. The number-average molecular weight, Mₙ, was determined by ¹H NMR spectroscopy and SEC analysis. The dispersity, Ð, was determined by SEC relative to polystyrene standards. PEO Mₙ=24.3 kg/mol, indicating complete conversion of the monomer; Ð of the overall SESO relative to PS standards was 1.12. ¹H NMR spectroscopy (400 MHZ, CDCl₃) δ:6.33-7.37 (m, 3449H, aromatic H), 3.50-3.67 (s, 2211H, PEO), 1.24-216 (6561, m alkane backbone).

Casting of Dense Polymer Films: Solutions of SESO and SV in toluene (20 wt %) were prepared by dissolving and stirring overnight. These solutions were cast onto a leveled glass plate and spread to an even thickness of 200 μm using a 4-inch Gardco doctor blade. The toluene was allowed to evaporate in the fume hood overnight, and the films were floated off the glass plate in water.

The films were dried under ambient conditions to constant weight and then under vacuum at room temperature overnight. They were used to characterize the mechanical properties without further modification. Based on thermogravimetric analysis (TGA), they had no appreciable residual toluene (FIGS. 2A-2D). Their average thickness was 20, 15, and 11 μm for the SESO-82 kDa, SESO-122 kDa, and 254 kDa SV, respectively.

Preparation of Polymer Dope (i.e., Casting Solution): To prepare casting solutions for SNIPS, target quantities of each solvent were mixed in 20 mL scintillation vials purged with dry nitrogen. To minimize evaporative losses, solvents were added in order of decreasing boiling point (i.e., dimethylformamide before 1,4-dioxane before tetrahydrofuran). The desired quantities of polymer were weighed and added to the solvent mixtures. Viscous solutions were left to rotate on a roller for at least two days before fabricating membranes. These solutions were visually homogenous before casting. Non-viscous solutions were mixed on a stir plate for at least two days before casting. In this work, weight ratios are used to reference the polymer composition of the casting solutions.

Casting of Isoporous and Mesoporous Membranes by SNIPS: Dope solutions were poured onto glass plates, cleaned with water/acetone and dried with a Kimwipe. Then, a 4-inch Gardco doctor blade was used to meter the solutions to a uniform thickness of 200 μm, and the dope solutions were allowed to partially dry in ambient air at ca. 23° C. and 50±5% relative humidity for 5-60 s. After this dry step, the dope solutions were immersed in a 23° C. DI water bath to form membranes by nonsolvent-induced phase separation.

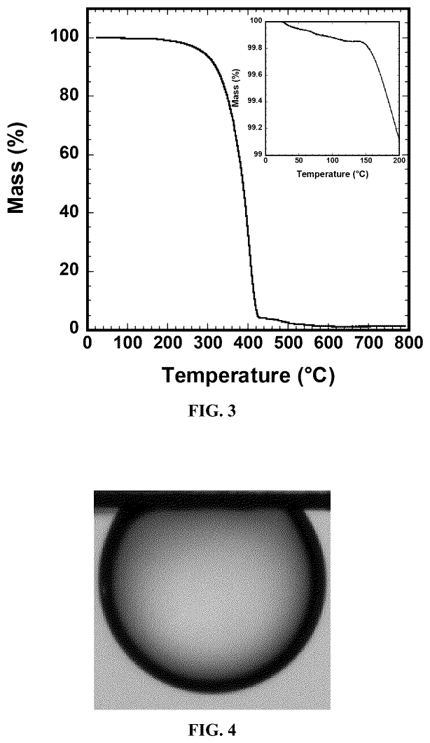

These membranes were first soaked in a beaker filled with DI water for 24 hours to allow the residual solvent to leach out. They were then solvent-exchanged for at least 2 h in a 50/50 (by volume) mixture of deionized water and methanol to prevent pore collapse during drying. The membranes were then dried overnight in air. Thermogravimetric analysis (TGA) confirmed the complete removal of the solvent from the membranes (FIG. 3).

Contact angle characterization is shown in FIG. 4.

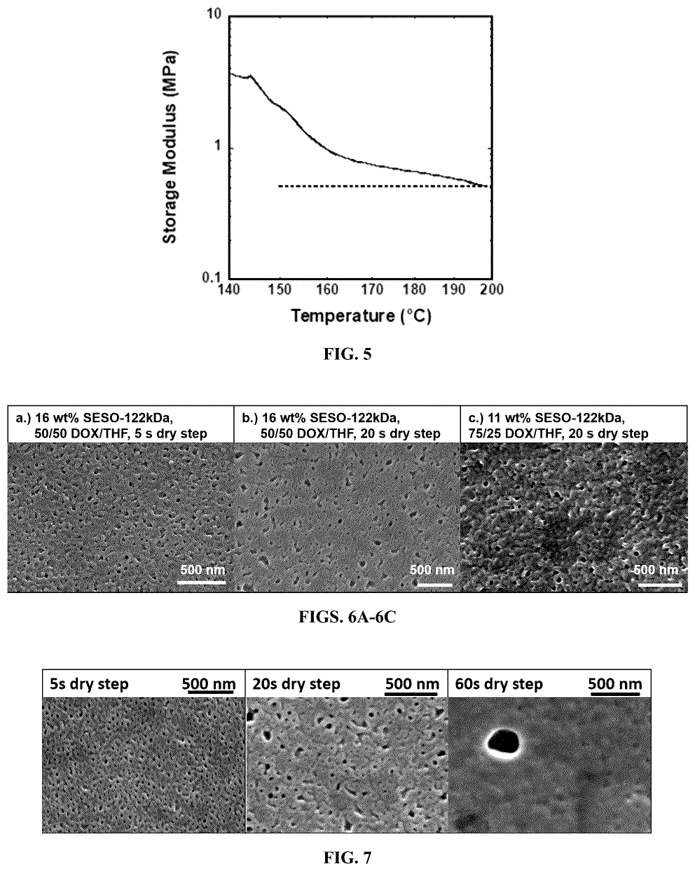

Calculation of Entanglement Molecular Weight: Entanglement densities were calculated from weight-averaged densities and entanglement molecular weights reported by Fetters, L. J. et al. Connection between Polymer Molecular Weight, Density, Chain Dimensions, and Melt Viscoelastic Properties. Macromolecules 1994, 27 (17), 4639-4647, or measured in the lab. The entanglement molecular weight of V could not be easily found, so it was calculated using the following equation:

$${M}_{e} = \frac{3 dRT}{{E}_{2}} \qquad ( EQ . 15 )$$

where d is the density (1.15 g/mL), R is the gas constant (8.314 cm³ MPa/mol K), T is the absolute temperature (298.15 K), and E₂ is the rubbery plateau of the stress relaxation modulus. This value was measured via dynamic mechanical analysis and was estimated to be 0.511 MPa, as shown in FIG. 5. Polymer densities and entanglement molecular weights for each block are listed below in TABLE 2.

TABLE 2
Physical property data for the polymer blocks used in
this study. Density values were sourced from Fetters
(Id.) or Chemical Book online CAS database list.

| | Density | Entanglement Molecular |
|---|---|---|
| Polymer | (g/cm³) | Weight (kg/mol) |
| Polystyrene | 0.969 | 13.309 |
| Poly(ethylene-alt-propylene) | 0.79 | 2.284 |
| Poly(ethylene oxide) | 1.064 | 1.624 |
| Poly(4-vinyl pyridine) | 1.15 | 16.728 |
| Polyisoprene | 0.83 | 5.429 |

Calculation of Hansen Solubility Parameters for Solvent Blends Used in Study: Hansen solubility parameters for the solvents are listed below in TABLE 3. The molar volume and Hansen solubility parameters for the blends were calculated from volume weighted averages of literature values (Karunakaran, M. et al. Isoporous PS-b-PEO Ultrafiltration Membranes via Self-Assembly and Water-Induced Phase Separation. J. Membr. Sci. 2014, 453, 471-477). The Hansen solubility parameters used for the polymers in this study are listed below in TABLE 4.

TABLE 3
Hansen solubility parameters (HSP) for solvents and solvent
blends used where δ_{D} stands for dispersion forces, δ_{P} for polarity,
and δ_{H} for hydrogen bonding. HSPs are in units of MPa^{1/2}.
V is the molar volume of the component in mL/mol (Brandrup,
J.; Immergut, E. H.; Grulke, E. A.; Abe, A.; Bloch, D. R. Polymer
Handbook, 4th ed.; Wiley: New York, NY, USA, 1999).

| Solvent | δ_{D} | δ_{P} | δ_{H} | V |
|---|---|---|---|---|
| THF | 16.8 | 5.7 | 8 | 81.9 |
| DOX | 17.5 | 1.8 | 9 | 85.7 |
| DMF | 17.4 | 13.7 | 11.3 | 77.4 |
| 75/25 DOX/THF | 17.3 | 2.9 | 8.7 | 84.7 |
| 50/50 DOX/THF | 17.1 | 3.9 | 8.5 | 83.7 |
| 33/33/33 DOX/DMF/THF | 17.2 | 7.2 | 9.4 | 81.6 |

TABLE 4
Hansen Solubility Parameters for polymers considered
in the study (Hansen, C. M. Hansen Solubility Parameters
A User's Handbook, 2nd ed.; CRC Press: Boca Raton, FL,
2007). HSPs are in units of MPa^{1/2}.

| Polymer | δ_{D} | δ_{P} | δ_{H} |
|---|---|---|---|
| Polystyrene (S) | 22.8 | 5.8 | 4.3 |
| Poly(ethylene) (E) | 16.8 | 3.8 | 3.8 |
| Poly(propylene (P) | 17.7 | 2.9 | 1.2 |
| Poly(ethylene oxide) (O) | 17.3 | 3.0 | 9.4 |
| Poly(4-vinylpyridine) (V) | 18.1 | 7.2 | 6.8 |

Polymer (1)-Solvent (2) χ's were calculated from the following equation (Müller, M. et al. Nonequilibrium Processes in Polymer Membrane Formation: Theory and Experiment. Chem. Rev. 2021, 121 (22), 14189-14231):

$${χ}_{1 , 2} = \frac{{VA}_{1 , 2}}{RT} \qquad ( EQ . 16 )$$

where V is the molar volume, R is the ideal gas constant, and T is the temperature. A_{1,2} is calculated from the Hansen solubility parameters as shown below (Id.):

$${A}_{1 , 2} = {( {δ}_{D 2} - {δ}_{D 1} )}^{2} + 0.25 {( {δ}_{P 2} - {δ}_{P 1} )}^{2} + 0.25 {( {δ}_{H 2} - {δ}_{H 1} )}^{2} \qquad ( EQ . 17 )$$

Differences in Hansen solubility parameters have been used to estimate thermodynamic favorability of the different blocks towards a particular solvent or solvent blend (Karunakaran, M. et al. Isoporous PS-b-PEO Ultrafiltration Membranes via Self-Assembly and Water-Induced Phase Separation. J. Membr. Sci. 2014, 453, 471-477). A larger difference in HSP values corresponds to less favorable interactions between that particular polymer block and the solvent or solvent blend. These differences for the 50/50 w/w solvent blend are shown below in TABLE 5 and those for the 75/25 w/w DOX/THF blend are recorded in TABLE 6 for the SESO polymer. TABLE 7 lists the values for SV for the 33/33/33 w/w/w DOX/DMF/THF solvent blend. To calculate the effective χ for the hydrophobic block (shown in TABLE 8), each of the χ's for each block segment can be weighed by the block volume fraction (TABLE 9).

TABLE 5
Differences in Hansen Solubility Parameters between polymer and
50/50 w/w DOX/THF solvent blend. Values have units of MPa.
50/50 DOX/THF Blend Hansen Solubility Parameters

| Dispersion Contribution | | Polar Contribution | | Hydrogen Bonding Contribution | |
|---|---|---|---|---|---|
| (δ_{Blend} − δ_{D}_{_{—}}_{O})² | 0.0 | (δ_{Blend} − δ_{P}_{_{—}}_{O})² | 0.8 | (δ_{Blend} − δ_{H}_{_{—}}_{O})² | 0.9 |
| (δ_{Blend} − δ_{D}_{_{—}}_{S})² | 32.2 | (δ_{Blend} − δ_{P}_{_{—}}_{S})² | 3.6 | (δ_{Blend} − δ_{H}_{_{—}}_{S})² | 17.3 |
| (δ_{Blend} − δ_{D}_{_{—}}_{E})² | 0.1 | (δ_{Blend} − δ_{P}_{_{—}}_{E})² | 0.0 | (δ_{Blend} − δ_{H}_{_{—}}_{E})² | 21.7 |
| (δ_{Blend} − δ_{D}_{_{—}}_{P})² | 0.3 | (δ_{Blend} − δ_{P}_{_{—}}_{P})² | 1.0 | (δ_{Blend} − δ_{H}_{_{—}}_{P})² | 52.7 |

TABLE 6
Differences in Hansen Solubility Parameters between polymer and
75/25 w/w DOX/THF solvent blend where the blend is a weighted
average of the individual solvent components. Values have units of MPa.
75/25 DOX/THF Blend Hansen Solubility Parameters

| Dispersion Contribution | | Polar Contribution | | Hydrogen Bonding Contribution | |
|---|---|---|---|---|---|
| (δ_{Blend} − δ_{D}_{_{—}}_{O})² | 0.0 | (δ_{Blend} − δ_{P}_{_{—}}_{O})² | 0.0 | (δ_{Blend} − δ_{H}_{_{—}}_{O})² | 0.4 |
| (δ_{Blend} − δ_{D}_{_{—}}_{S})² | 30.0 | (δ_{Blend} − δ_{P}_{_{—}}_{S})² | 8.5 | (δ_{Blend} − δ_{H}_{_{—}}_{S})² | 19.6 |
| (δ_{Blend} − δ_{D}_{_{—}}_{E})² | 0.3 | (δ_{Blend} − δ_{P}_{_{—}}_{E})² | 0.8 | (δ_{Blend} − δ_{H}_{_{—}}_{E})² | 24.3 |
| (δ_{Blend} − δ_{D}_{_{—}}_{P})² | 0.1 | (δ_{Blend} − δ_{P}_{_{—}}_{P})² | 0.0 | (δ_{Blend} − δ_{H}_{_{—}}_{P})² | 56.7 |

TABLE 7
Differences in Hansen Solubility Parameters between SV and 33/33/33
DOX/DMF/THF w/w/w solvent blend where the blend is a volume
weighted average of the individual solvent components. Values have units
of MPa. 33/33/33 DOX/DMF/THF Blend Hansen Solubility Parameters

| | | | | Hydrogen Bonding | |
|---|---|---|---|---|---|
| Dispersion Contribution | | Polar Contribution | | Contribution | |
| (δ_{Blend} − δ_{V})² | 0.8 | (δ_{Blend} − δ_{V})² | 0.0 | (δ_{Blend} − δ_{V})² | 6.8 |
| (δ_{Blend} − δ_{S})² | 31.2 | (δ_{Blend} − δ_{S})² | 1.9 | (δ_{Blend} − δ_{S})² | 26.2 |

TABLE 8
χ value estimates between polymer blocks and the two solvent
blends used in this study. HSPs for the solvent blends are calculated
using a volume fraction weighted average of the pure component HSPs,
and these parameters are used to calculate the χ₁₋₂ values,
where 1 is the polymer and 2 is the solvent.

| | | | 75/25 | 50/50 | 33/33/33 |
|---|---|---|---|---|---|
| χ₁₋₂ | THF | DOX | DOX/THF | DOX/THF | DOX/DMF/THF |
| polystyrene | 1.30 | 0.02 | 0.22 | 0.19 | 1.26 |
| polyethylene | 0.18 | 0.29 | 0.22 | 0.19 | 0.36 |
| polypropylene | 0.47 | 1.89 | 0.49 | 0.46 | 0.71 |
| poly(ethylene | 0.08 | 0.02 | 0.00 | 0.02 | 0.14 |
| oxide) | | | | | |
| poly(4-vinyl | 0.09 | 0.31 | 0.21 | 0.15 | 0.08 |
| pyridine) | | | | | |

TABLE 9
Block copolymers used to cast mesoporous membranes.

| | Mₙ | | | | νₑ |
|---|---|---|---|---|---|
| Polymer | (kDa)^{a} | ϕ_{S}^{b} | ϕ_{R}^{c} | ϕ_{H}^{d} | (1 × 10²⁵ chains/m³)^{e} |
| SV* | 254 | 0.77 | 0 | 0.23 | 4.5 |
| ISV^{#} | 77 | 0.56 | 0.29 | 0.15 | 6.0 |
| SESO-122 kDa | 122 | 0.57 | 0.26 | 0.17 | 15.1 |
| SESO-82 kDa | 82 | 0.42 | 0.39 | 0.19 | 18.0 |

^{a}Number-average molecular weight.
Volume fractions of
^{b}glassy PS,
^{c}rubbery PI or PEP, and
^{d}hydrophilic P4VP or PEO.
^{e}Entanglement density.
The SV polymer used in this study was purchased from Polymer Source, Inc.
^{#}The ISV polymer was reported by Phillip, et al. (Id.).

### Polymer Solution Properties

Choice of Polymer Concentration and Dry Step Time: SNIPS can involve optimization of both the polymer concentration and the dry step evaporation time step before the nascent membrane is quenched in water. The quenching step is both a kinetically and thermodynamically driven non-equilibrium process, vitrifying the membrane in a nonequilibrium structure by the influx of nonsolvent (i.e., water). Polymer concentration and dry step time are interconnected because polymer concentration influences the polymer solution viscosity, which in turn influences the dynamics and interactions of the polymer chains during the dry step time. Therefore, these variables can be optimized so that the morphology needed to produce an isoporous membrane exists at the time the transient polymer structure in solution is vitrified by the influx of water into the system.

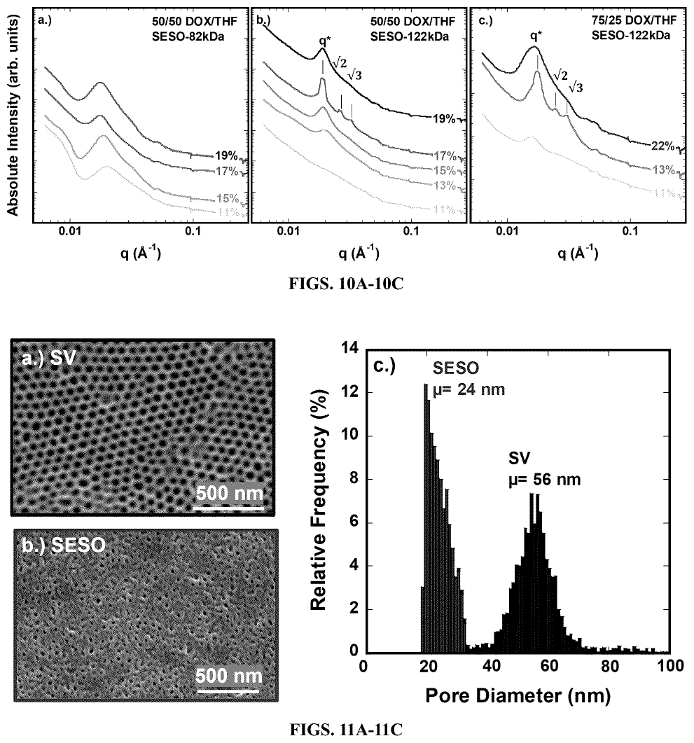

To achieve an isoporous membrane, previous studies have demonstrated the effect of the starting polymer solution being located on or near the order-disorder boundary (Gu, Y. et al. In situ Study of Evaporation-Induced Surface Structure Evolution in Asymmetric Triblock Terpolymer Membranes. Macromolecules 2016, 49 (11), 4195-4201). Most successful isoporous membrane casting solutions use polymer concentrations that are slightly below the concentration at which ordering is seen (Radjabian, M. et al. Influence of Solvent on the Structure of an Amphiphilic Block Copolymer in Solution and in Formation of an Integral Asymmetric Membrane. ACS Appl. Mater. Interfaces 2017, 9 (37), 31224-31234). As the volatile solvent evaporates during the dry step, the polymer concentration near the air-solution interface increases, bringing the micelles closer to one another before quenching in water. A longer dry step concentrates the micelles at the surface more, which is helpful for isoporous membrane formation if the casting concentration is significantly lower than the concentration required for ordering. However, if the dry step is too long, the optimal window for ordering may pass (Müller, M. et al. Nonequilibrium Processes in Polymer Membrane Formation: Theory and Experiment. Chem. Rev. 2021, 121 (22), 14189-14231). Castings were done to attempt to place the surface concentration at the ordered states seen in the solution SAXS data in FIGS. 10A-10C. These castings are shown below in FIGS. 6A-6C. Unfortunately, these castings were unable to capture the ordered solution state on the final membrane morphology after the SNIPS process. These results highlight some of the drawbacks to only having solution SAXS data, which cannot capture how the order changes during the dry step.

For this study, shorter dry steps, around 5 s, were necessary, as the necessary ordering was presumably lost during longer dry steps (≥10 s) (see FIG. 7) for the castings at high polymer concentration (i.e., 22 wt %). At these longer dry steps, the solvent blend presumably becomes more favorable for PS because the solvent blend becomes enriched in DOX as the more volatile THF evaporates. At these longer dry step times, the micelle structure may be disrupted because there is only a very small difference in χ parameters between PS and PEO, which may allow the system to relax into a more disordered state, which is not suitable for isoporous membrane formation (Frielinghaus, H. et al. Differences of Interaction Parameter of a PS/PEO Homopolymer Blend and Diblock Copolymer in Comparison to Other Systems. Macromol. Symp. 2000, 149 (1), 63-68).

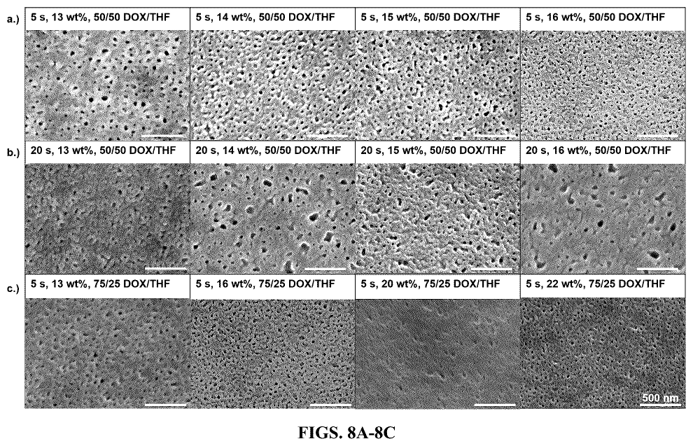

The relative composition of THF in the blend can be important because this solvent is more volatile than DOX and thus evaporates more quickly during the dry step, concentrating the polymer in a solution that becomes enriched in the less volatile solvent. Three blends were tested: 75/25, 50/50, and 25/75 DOX/THF by weight. The 25/75 DOX/THF blend formed dense membranes, most likely because of THF's low miscibility with water. The 50/50 DOX/THF blend had a lower viscosity than the 75/25 blend at the same polymer concentration, making the 50/50 blend easier to cast into a thin film. However, this low viscosity also allowed the polymer chains to relax more quickly during the dry step, which may have led to a more disordered surface. The more viscous 75/25 solvent blend produced membranes with the smallest pore size distribution, as shown in FIGS. 8A-8C. This figure shows SEM images at various polymer concentrations using 5 s and 20 s dry step evaporation times for the 50/50 w/w DOX/THF blend, as well as membranes cast from 75/25 w/w DOX/THF using a 5 s dry step evaporation time. For the 50/50 w/w blend, the optimal (i.e., narrowest pore size distribution) casting formulation and conditions were a 15 wt % polymer solution with a 5 s evaporation step. For the 75/25 w/w blend, 13 wt % and 22 wt % polymer concentrations with a 5 s evaporation step produced the smallest pores and most uniform isoporous morphology based on the pore size distributions for these membranes. Because this solvent blend contained less THF, it would presumably experience reduced THF loss relative to the 50/50 w/w DOX/THF blend at similar evaporation times, necessitating a higher polymer concentration to reach the required solution structure to form an isoporous, ordered skin layer.

### Results and Discussion

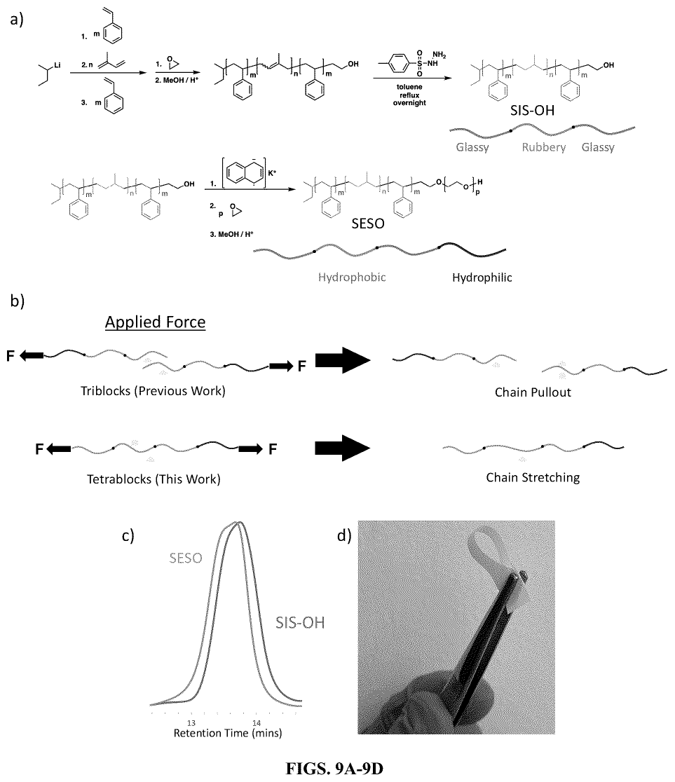

Tetrablock polymer design: The hydrophobic triblock copolymer, SIS, was synthesized via sequential anionic polymerization, initiating from sec-butyllithium in cyclohexane (FIG. 9A). The relative block size for the polyisoprene rubbery block was informed by the study of Phillip et al. (Id.) to test the hypothesis that bridging two glassy polymer blocks with a rubbery block would toughen mesoporous membranes (FIG. 9B). The composition of the ca. 98 kDa hydrophobic triblock polymer was targeted to be 27 wt % polyisoprene (PI), with the remaining 73 wt % split evenly between the two polystyrene (PS) blocks. This architecture was chosen to create a continuous, glassy phase filled with discrete rubbery domains (cf., FIG. 9D). Upon 100% monomer conversion, the polystyryl anions were terminated with a single unit of ethylene oxide to cap them with a functional handle that could be chain extended through the alkoxide-initiated anionic ring-opening polymerization of ethylene oxide (cf., FIG. 9C) (Hillmyer, et al., Id.). Prior to this chain extension, and to reduce the likelihood of oxidative degradation, the polyisoprene block was chemically reduced to poly(ethylene-alt-propylene) (PEP) using 4-methylbenzenesulphonylhydrazide (Tureau, et al., Id.). This reaction proceeded to 95% conversion, as determined by ¹H NMR spectroscopy.

The hydrophilic block was synthesized by epoxide ring-opening polymerization of ethylene oxide. PEO was chosen as the hydrophilic block because of its resistance to fouling (cf., FIG. 4). This feature is ideal for separating proteins, viruses, or other organic matter by UF, and stems from the lack of charge on PEO and its ability to act only as a hydrogen bond acceptor (Ostuni, E. et al. A Survey of Structure—Property Relationships of Surfaces That Resist the Adsorption of Protein. Langmuir 2001, 17 (18), 5605-5620). Additionally, whereas a P4VP hydrophilic block may swell or shrink with pH changes, altering the permeability and selectivity of the membrane, a PEO-based pore will remain pH-insensitive (Clodt, J. I. et al. Double Stimuli-Responsive Isoporous Membranes via Post-Modification of pH-Sensitive Self-Assembled Diblock Copolymer Membranes. Adv. Funct. Mater. 2013, 23 (6), 731-738).

For the rubbery midblock to increase the toughness of mesoporous membranes, the molecular weight of the tetrablock polymer must be above a certain threshold. After all, the block copolymer must self-assemble in solution and entangle in the solid. With that consideration in mind, the study focused on two polymers with different molecular weights. The first had a hydrophobic (matrix-forming) block size of 12.3 kDa PEP, 33.5 kDa PS split between the two PS blocks, and a hydrophilic PEO block size of 36.2 kDa, for an overall molecular weight of ca. 82 kDa. The second had a hydrophobic block size of 71.8 kDa PS, 26.4 kDa PEP, and a hydrophilic block size of 24.3 kDa for an overall molecular weight of ca. 122 kDa. These molecular weights were determined by ¹H NMR spectroscopy and used to estimate the entanglement densities according to (Kramer et al. Id.):

$${v}_{e} = {\sum }_{i = 1}^{n} {ϕ}_{i} \frac{{ρ}_{i} {N}_{A}}{{M}_{e , i}} \qquad ( EQ . 18 )$$

In this equation, vₑ is the entanglement density in chains/m³, φᵢ is the volume fraction of the i^{th} block, ρᵢ is the density of the i^{th} block, N_{A} is Avogadro's number, and M_{e,i} is the entanglement molecular weight of the i^{th} block. Densities and entanglement molecular weights for each polymer block are listed in TABLE 2, and the entanglement densities for the SESO tetrablock polymers, a widely-reported SV, and the ISV introduced by Phillip et al. are summarized in TABLE 9 (Hilke, R. et al. Block Copolymer/Homopolymer Dual-Layer Hollow Fiber Membranes. J. Membr. Sci. 2014, 472, 39-44; Dorin, R. M. et al. Solution Small-Angle X-Ray Scattering as a Screening and Predictive Tool in the Fabrication of Asymmetric Block Copolymer Membranes. ACS Macro Lett. 2012, 1 (5), 614-617).

The key observation in TABLE 9 is that the two SESO tetrablock copolymers, SESO-122 kDa and SESO-82 kDa, have higher entanglement densities, vₑ, than the commercial SV (Mₙ=254 kDa) and the ISV reported by Phillip et al. (Id.). The reason is the packing length of PEP and PEO, p≈0.2 nm, relative to that of PS and P4VP, p≈0.4 nm (Fetters, et al. 1999, Id.). Low packing lengths and high entanglement densities, particularly of the SES hydrophobic block, are essential for rationalizing the mechanical and transport properties of mesoporous membranes (Fetters, et al., 1994, Id.).

Casting of Mesoporous Membranes: Having discussed the design and synthesis of the SESO tetrablock polymers, the study next focused on choosing and optimizing the casting conditions that can ultimately afford mesoporous membranes. In this regard, block copolymer solutions in solvents that preferentially interact with one block over the other can drive solution self-assembly and template the surface structure of the membrane (Peinemann et al. Id.; Grzetic et al., Id.). However, one notable challenge with utilizing PEO is that its interaction parameter with PS at room temperature is orders of magnitude lower than that of the hydrophilic block most commonly used in SNIPS, P4VP, χ_{PS-PEO}=0.052 vs. χ_{PS-P4VP}=1.4-7.5 (Antoine, S. et al. Non-Intuitive Trends in Flory-Huggins Interaction Parameters in Polyether-Based Polymers. Macromolecules 2021, 54 (14), 6670-6677; Clarke, C. J. et al. Measurements of the Flory-Huggins Interaction Parameter for Polystyrene-Poly(4-Vinylpyridine) Blends. Macromolecules 1997, 30 (14), 4184-4188). Hence, SESO polymers do not easily self-assemble in solutions of non-selective solvents. This effect can somewhat be counteracted by increasing the molecular weight of the polymers. However, similar to using block copolymers for lithography (Sinturel, C. et al. High χ-Low N Block Polymers: How Far Can We Go? ACS Macro Lett. 2015, 4 (9), 1044-1050), this increase also enlarges the pores and compromises selectivity and rejection of the membrane (Rangou, S. et al. Self-Organized Isoporous Membranes with Tailored Pore Sizes. J. Membr. Sci. 2014, 451, 266-275). A strategy for casting weakly segregated (i.e., low χ) block copolymers from solvents that facilitate ordering in solution is essential for attaining mesoporous membranes with small and narrowly dispersed surface pores.

Given the low χ between PS and PEO, χ_{PS-PEO}, finding a solvent blend strongly selective for one block over the other can take effort. After all, these polymers are soluble in many of the same solvents (e.g., THF, chloroform, and DOX). The interaction parameter of various solvents were estimated with each block, χ_{polymer-solvent}, using Hansen solubility parameters (HSPs) (cf., Eqs. S2 and S3) (Hansen, C. M. Hansen Solubility Parameters A User's Handbook, 2nd ed.; CRC Press: Boca Raton, FL, 2007). These parameters are listed in TABLE 10, and the values of the HSPs are shown in TABLE 3. The approximations of the solvent blend as a single solvent and the SES triblock as a single block affect this analysis.

TABLE 10
χ parameter estimates between polymer blocks and the solvent
blends used in this study. HSPs for the solvent blends are
calculated using a volume-weighted average of the pure component
HSPs, and these parameters are used to calculate the χ_{polymer-solvent}.
The SES parameters are calculated by taking a volume-weighted
average of the pure polymer values found in TABLE 8, where the
block fractions come from the hydrophobic block for the
SESO-122 kDa polymer. DOX/THF mixture compositions
are given in mass ratio (w/w).

| | THF | 75/25 DOX/THF | 50/50 DOX/THF | DOX |
|---|---|---|---|---|
| χ_{PSES-solvent} | 1.0 | 0.26 | 0.23 | 0.12 |
| χ_{PEO-solvent} | 0.08 | 0.00 | 0.02 | 0.02 |
| Δχ | 0.92 | 0.26 | 0.21 | 0.10 |

The study first considered the interactions of THF and DOX with the hydrophobic SES triblock. These solvents have interaction parameters χ_{PSES-THF}=1.00 and χ_{PSES-DOX}=0.12, indicating that they have drastically different qualities. THF is a very poor solvent for SES, whereas DOX is less poor. The interactions with the hydrophilic block, PEO, are also noteworthy. THF is a slightly poor solvent for PEO, χ_{PEO-THF}=0.08, whereas DOX is essentially athermal with χ_{PEO-DOX}=0.02. Therefore, the study leveraged DOX and THF to control the selectivity of the solvent for the SES block over the PEO, Δχ=χ_{PSES-solvent}−χ_{PEO-solvent}, and drive the solution self-assembly of the SESO tetrablock polymers. While this selectivity can, in principle, be tuned from Δχ=0.92 for pure THF to Δχ=0.10 for pure DOX, the study restricted attention to 75/25 and 50/50 w/w DOX/THF blends, where the solvent quality is slightly poor, the selectivity for the PEO block is weak, Δχ=0.2−0.3, and the solvent is still miscible with the nonsolvent (i.e., water).

To examine the self-assembly of SESO polymers in these solvent blends, the study measured X-ray scattering profiles by SAXS (FIGS. 10A-10C). In 50/50 w/w DOX/THF, the profiles corresponding to the SESO-82 kDa polymer (FIG. 10A) exhibit an apparent structure factor peak at a scattering vector, q*, that decreases with polymer concentration. This observation indicates that the SESO-82 kDa polymer assembles into micelles in this solvent blend, with a characteristic spacing (i.e., intermicellar distance) that increases from 29.5 nm at 11 wt % polymer to 36.7 nm at 19 wt % polymer. However, the larger SESO-122 kDa assembles differently (FIG. 10B). The scattering profile does not exhibit any scattering peaks at 11 wt % because the polymer is disordered. At 13 wt %, it exhibits only a primary scattering peak at q*=2.0 Å⁻¹, which indicates that the polymer assembles into a micellar structure with domain spacing of d=31.4 nm. Finally, at 17 wt %, the scattering profile exhibits primary and higher order structure factor peaks at q/q*=1, √2, √3, indicative of micelle packing into a BCC lattice (Hamley, I. Block Copolymers in Solution: Fundamentals and Applications, 1st ed.; John Wiley & Sons, Ltd.: West Sussex, England, 2005). In 75/25 DOX/THF, the phase behavior of the SESO-122 kDa polymer is similar, but the micellar-to-BCC transition occurs at 13 wt % instead (FIG. 10C).

Together, these observations reveal that increasing the molecular weight of SESO from 82 to 112 kDa results in higher segregation strengths (i.e., χN) and improved long-range order of micelles in solution. These observations are important for membrane science for several reasons. First, higher molecular weights lead to mesoporous membranes with larger pores, as recently demonstrated by Rangou and co-workers (Rangou, S. et al. Self-Organized Isoporous Membranes with Tailored Pore Sizes. J. Membr. Sci. 2014, 451, 266-275). This assessment of the polymer-solvent interaction parameters, χ_{polymer-solvent} (TABLE 10), and the solution structure (FIGS. 10A-10C) highlights a pathway to rationally drive self-assembly of weakly segregated block copolymers (i.e., low χN) and cast them into mechanically robust mesoporous membranes with surface pores that are smaller than those obtained with the brittle (i.e., low molecular weight) and widely-used SV polymer (Yu, et al., Id.; Hilke, et al., Id.; Dorin, et al. Id.). However, it is noted that similarly small pores can also be obtained by quaternizing the P4VP block or electrodepositing gold in mechanically robust (i.e., high molecular weight) mesoporous SV membranes (Qui, et al, Id.; Yu, et al. Id.; Zhang et al. 2019, Id.). Second, the long-range order observed in SESO-122 kDa solutions at a concentration of 17 wt % polymer in 50/50 w/w DOX/THF (or 13 wt % polymer in 75/25 w/w DOX/THF) suggests that membranes cast from such solutions would have narrowly dispersed surface pores.

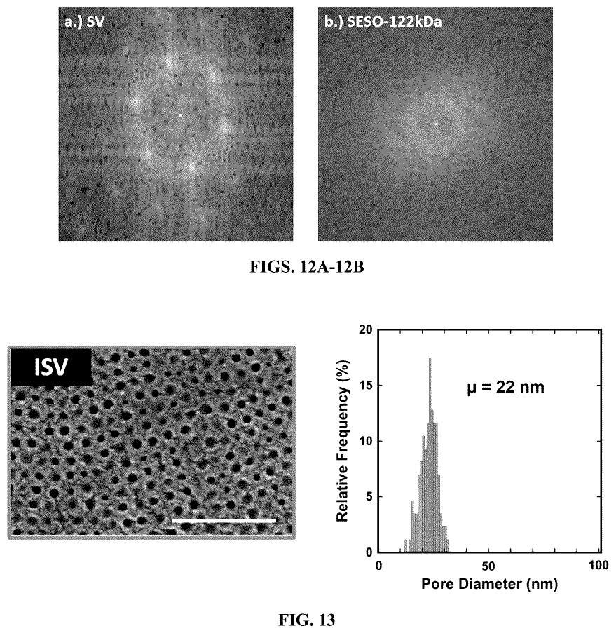

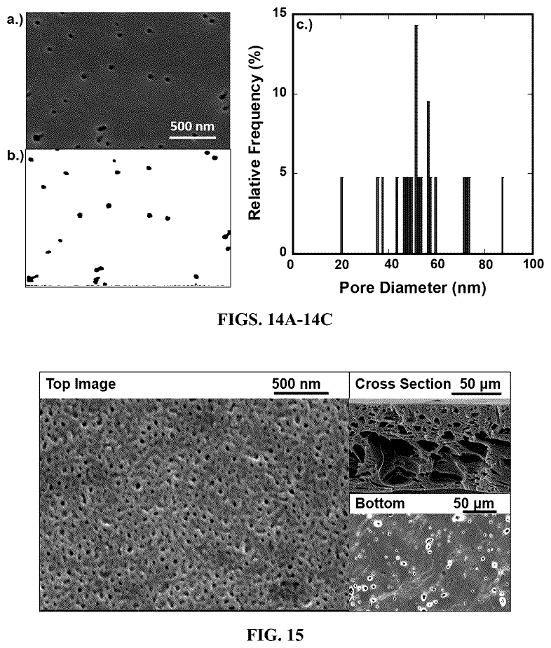

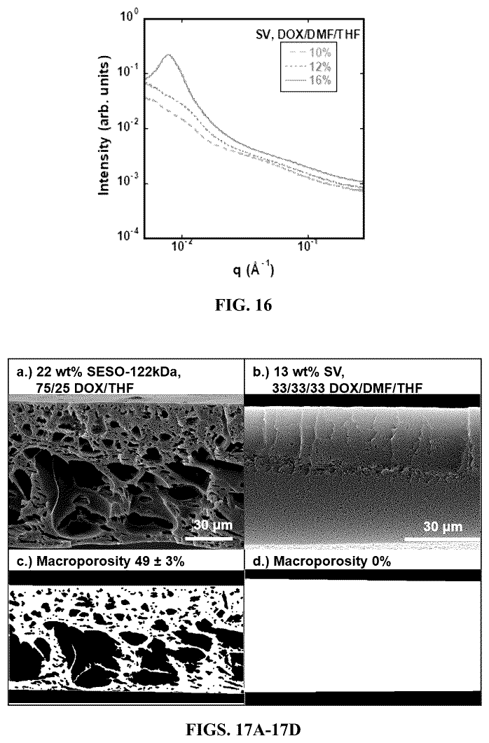

Based on these observations, ordered solutions of SESO-122 kDa (i.e., assembled in a BCC lattice) were cast into mesoporous membranes by blade coating them onto a glass substrate and immersing them in water. Remarkably, the membranes cast from a 17 wt % polymer solution of SESO-122 kDa in 50/50 w/w DOX/THF and a 13 wt % polymer solution in 75/25 w/w DOX/THF had broadly dispersed surface pores. In contrast, the membrane cast from a 22 wt % polymer solution in 75/25 w/w DOX/THF, likely less ordered in solution based on the sharpness of the scattering peaks, had narrowly dispersed pores with an average size of μ=24 nm, a standard deviation of σ=4 nm, and variability of σ/μ=0.16 (see the SEM image of the surface layer in FIG. 11B and pore size distribution in FIG. 11C). This difference in surface structure highlights three important points. The first is that the mesoporous SESO-122 kDa membrane (i.e., cast from a 22 wt % solution in 75/25 DOX/THF) has a pore size variability in line with that of block copolymers (σ/μ=0.25), and below that of more conventional polymer membranes σ/μ=0.42 (Hampu, et al., Id.). The second is that this membrane has smaller and more disorganized pores than the commercial SV widely used in the literature and cast using 33/33/33 DOX/THF/DMF following a procedure reported by Qiu et al. (Id.) (cf., FIG. 11A, μ=56 nm, σ=10 nm, and σ/μ=0.18, and FFT of the SEM images in FIGS. 12A-12B). It also has a comparable pore size distribution to the ISV membrane of Phillip et al. (cf., FIG. 13, μ=22 nm, σ=3.7 nm, and σ/μ=0.17) (Phillip, et al., Id.). Finally, the solution self-assembly of block copolymers into ordered structures, as driven by the polymer molecular weight and the intermolecular interaction parameters (i.e., the solvent quality) and observed by solution SAXS, is insufficient to cast membranes with narrowly dispersed surface pores, consistent with previous observations from Radjabian et al. (Radjabian, et al., 2017, Id.). Pore size distributions were created from binarized images, and an example is shown in FIGS. 14A-14C. The bottom surface of the SESO-122 kDa membrane is shown in FIG. 15. Solution SAXS for the SV polymer in 33/33/33 w/w/w DOX/DMF/THF is shown in FIG. 16.

The study offers two plausible explanations for this last point. The first is thermodynamic and concerns the difference in block copolymer structure between the surface of the solution and the bulk. The scattering profiles of SESO-122 kDa solutions in 17 wt % polymer in 50/50 w/w DOX/THF and 13 wt % polymer in 75/25 w/w DOX/THF indicate long-range order in bulk but do not provide information on the structure of the tetrablock copolymer at the surface (i.e., at the air-solution interface). This structure likely templates the surface pores and evolves during the dry step due to interfacial tension and solvent evaporation (i.e., local composition variations) (Paradiso, S. P. et al. Block Copolymer Self Assembly during Rapid Solvent Evaporation: Insights into Cylinder Growth and Stability. ACS Macro Lett. 2014, 3 (1), 16-20). The second explanation is kinetic and relates to the rate of solvent and nonsolvent interdiffusion during the wet immersion step relative to that of polymer vitrification and kinetic arrest. These rates depend on features such as the polymer molecular weight and the interaction parameters, but also on the overlap concentration and the solution (i.e., dope) viscosity. This viscosity was low in the 17 wt % polymer solution in 50/50 w/w DOX/THF and the 13 wt % polymer solution in 75/25 w/w DOX/THF and could have led to considerable solvent-nonsolvent interdiffusion before the vitrification of the pores. Instead, the 22 wt % polymer dope in 75/25 w/w DOX/THF had a higher viscosity, possibly allowing the pores to vitrify rapidly upon phase inversion. Though these explanations are plausible and reasonable, they may require further experimental and theoretical validation.

Clearly, the casting conditions and the molecular weight of the block copolymer impact the distribution of the surface pores. However, they also affect the membrane's substructure. To examine this effect, the study imaged the cross-sectional area of mesoporous SESO-122 kDa and SV membranes using SEM (see FIGS. 17A-17B). The study then quantified the substructure macroporosity (i.e., macrovoid content) Dₘ, by thresholding the SEM images and calculating the areal fraction of large pores (see images in FIGS. 17C-17D; details of the thresholding procedure are discussed above and in Bridge et al. (Id.)). The SESO-122 kDa membrane had a substructure significantly more porous than that of the completely microporous SV and ISV (Phillip, et al. Id.), with a macroporosity of Dₘ≈0.49. This porous substructure is crucial to recognize, as it plays a key role in the bulk mechanical and transport properties. After all, large voids can act as structural defects or cracks while also minimizing resistance to water flow.

Mechanical Properties Characterization: Having discussed the synthesis, casting, and structure of the SESO-122 kDa membrane, the study next focused on its mechanical properties. This SESO membrane has a rubbery midblock anchored between the matrix-forming PS blocks, leading to hypothesizing that it would be tougher than SV and ISV.

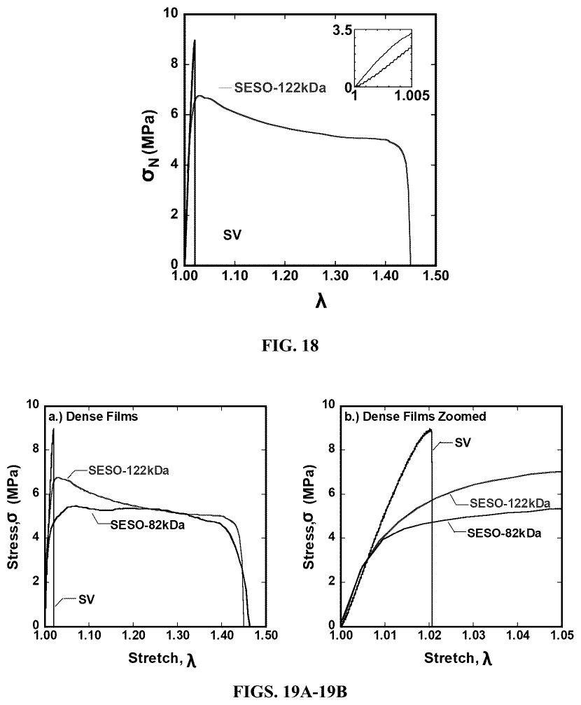

To validate this hypothesis, the study examined the tensile properties of the SESO-122 kDa and the SV polymers in their dense state (FIG. 18). These materials had elastic modulus values, E_{SV}≈0.80 GPa and E_{SESO}≈1.1 GPa, at low strains characteristic of polymer glasses (see inset in FIG. 18). However, their mechanical properties notably differed at large strains. Specifically, the SV polymer was brittle, with a high tensile strength of σ_{f}=9.3 MPa and a very low stretch at break of λ_{f}=1.02. In contrast, the SESO-122 kDa polymer was ductile, with a σ_{f}=7.5 MPa and a λ_{f}≈1.45. The study ascribed this difference in large-strain properties to the contrasting packing lengths and entanglement densities of the polymers (see TABLE 9). Brittle polymers like SV include PS and P4VP blocks with low entanglement densities and high packing lengths, whereas ductile polymers like SESO contain an anchored PEP block that packs effectively in space and is rubbery, facilitating chain entanglements and toughening. Notably, the SESO 82-kDa tetrablock polymer was also ductile (see stress-strain curves in FIGS. 19A-19B).

The study also considered the mechanical properties of the mesoporous membranes (FIGS. 20A-20B). Similar to the dense polymers, the SV membranes were brittle, and the SESO-122 kDa membranes were ductile. However, unlike the dense polymers, the SESO-122 kDa membrane was stronger. This SESO-122 kDa membrane had a tensile strength of σ_{f,SESO}=1.05 MPa, which was higher than that of the SV, σ_{f,SV}=0.6 MPa, despite being significantly more porous, Dₘ=0.49 (see tensile curves in FIG. 20A and the SEM images in FIGS. 17A-17D). This observation led to postulating that the polymer (i.e., solid) phase within the SESO membrane could withstand more stress than indicated by the nominal stress, σ_{N}.

To account for the difference in substructure porosity, the study renormalized the nominal stress, ON, by the macroporosity, Dₘ, to estimate the stress carried by the polymer phase within the membrane, σ_{N}^{Polymer} (see FIG. 20B), as is typically done in composites (Chawla, K. K. Composite Materials: Science and Engineering; Springer International Publishing: Cham, 2019; Millereau, P. et al. Mechanics of Elastomeric Molecular Composites. Proc. Natl. Acad. Sci. 2018, 115 (37), 9110-9115):

$${σ}_{N}^{Polymer} = \frac{F}{{A}_{cross} ( 1 - {D}_{m} )} = \frac{{σ}_{N}}{1 - {D}_{m}} \qquad ( EQ . 19 )$$

The stress-strain curve of the SV membrane did not change due to the absence of large voids in its substructure, Dₘ≈0. However, the stress-strain curve of the SESO-122 kDa membrane drastically shifted, revealing a tensile strength for the polymer phase of σ_{f,SESO}^{Polymer}=2.3 MPa, considerably above that of SV, σ_{f,SV}^{Polymer}=0.6 MPa. Thus, the PEP midblock indeed toughens and strengthens the membrane by allowing it to withstand much higher stresses and strains, both in the absence and presence of large pores. The brittle behavior of SV leads to mesoporous membranes that readily fracture, whereas the rubber-toughened SESO-122 kDa membrane can have large defects in the form of voids while withstanding moderate strains.

TABLE 11 summarizes the mechanical properties of the membranes prepared from SESO-122 kDa and SV, as well as those reported by Phillip et al. for ISV (Phillip, et al., Id.). Notably, the SESO-122 kDa membrane exhibited a higher tensile strength, stretch at break, and work-to-fracture (i.e., area under the stress-stretch curve) than that of SV and ISV, highlighting the value of the tetrablock architecture for mechanical properties. The material essentially allows the casting of mesoporous membranes with narrowly dispersed, small pores (μ=24 nm, σ/μ=0.16, FIGS. 11A-11B), and improved mechanical properties (FIGS. 20A-20B).

TABLE 11
Mechanical properties and macroporosity of
SESO-122 kDa and SV asymmetric membranes.

| Polymer | Dₘ^{a} (%) | σ_{f} (MPa) | λ_{f} | E (MPa) | W (kJ/m³) |
|---|---|---|---|---|---|
| SESO- | 49 ± 3 | 1.05 ± 0.02 | 1.22 ± 0.05 | 80 ± 14 | 200 ± 50 |
| 122 | | | | | |
| kDa | | | | | |
| SV | 0 ± 0 | 0.6 ± 0.2 | 1.009 ± 0.004 | 87 ± 22 | 2.6 ± 1.5 |

^{a}Macroporosity by image analysis of cross-sectional SEM micrographs displayed in FIGS. 17A-17D, and the error bars represent the 68% confidence intervals (i.e., ±1 standard error) from triplicate values.

Characterization of Membrane Transport Properties: Having established the effect of the rubbery PEP block on the mechanical properties of the SESO-122 kDa membrane, the study finally focused on the influence of the porous substructure on the hydrodynamic resistance to water flow. To this end, the study examined the steady-state water flux, J, of the SESO-122 kDa membrane and compared it to that of a commercial track-etched polycarbonate (PC) membrane with twice its average pore size, μ=54±14 nm (FIGS. 21A-21B). Two features are worth noting in the permeation curves. The first is the range of transmembrane pressures sustained by the membranes (1.0-4.0 bar), which is considerably above the one that can be imposed on SV and ISV membranes without compromising their mechanical properties and breaking them (ca. 0.1-2.0 bar) (Peinemann, et al., Id.; Phillip, et al., Id.; Qui, et al., Id.; Yu, et al. Id.; Rangou et al., 2014, Id.). The second is the magnitude of the water permeance, P, which is higher in the SESO-122 kDa, P_{SESO}=671 LMH/bar, than in the PC membrane, P_{PC}=373 LMH/bar.

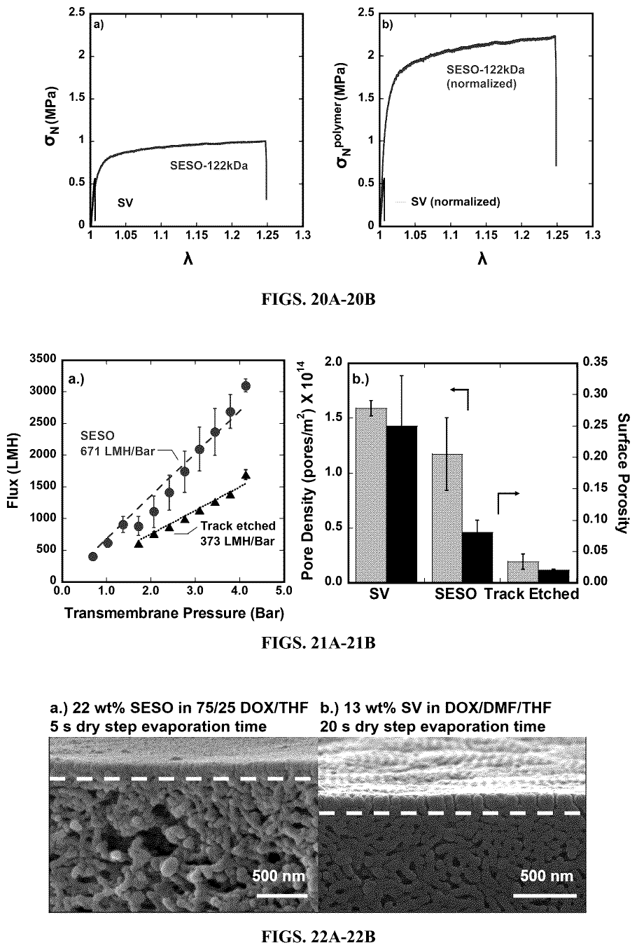

The study ascribes this difference in water permeance to the surface density of the pores, σₚ. This density, estimated via SEM (FIGS. 11A-11C), was significantly higher in the SESO-122 kDa, σₚ=(1.2±0.3)×10¹⁴ pores/m² than in the PC membrane, σₚ=(1.9±0.7)×10¹³, consistent with the processes used in manufacturing-SNIPS and track-etching, respectively. Moreover, it served to evaluate the substructure resistance to hydrodynamic flow, allowing estimation of an effective pore size, d_{H}, assuming Hagen-Poiseuille flow and a selective layer thickness of ca. 100 nm (see the magnified cross-sectional images of the membranes used to estimate the selective layer thickness in FIGS. 22A-22B). This size, d_{H}=16 nm, was in close agreement with that observed at the membrane surface by SEM, μ=24 nm, indicating minimal resistance to hydrodynamic flow in the SESO-122 kDa membrane. Hence, the tetrablock polymer architecture simultaneously enhances both the mechanical and transport properties, facilitating the formation of porous mesostructures with polymer phases capable of withstanding substantial stress or transmembrane pressure without catastrophically failing.

### Conclusions

Robust, mesoporous membranes were cast from solutions of poly(styrene-b-(ethylene-alt-propylene)-b-styrene-b-ethylene oxide) (SESO) ABAC tetrablock polymers and water. These polymers were synthesized from a reduced ω-hydroxy functional poly(styrene-b-(cis-1,4-isoprene)-b-styrene) (SIS-OH) precursor, SES-OH, through the anionic ring-opening polymerization of ethylene oxide (EO). The most isoporous membrane was formed via block copolymer self-assembly combined with nonsolvent induced phase separation (SNIPS), using a 22 wt % SESO-122 kDa solution in a 75/25 w/w 1,4-dioxane/tetrahydrofuran (DOX/THF) blend, followed by a 5-second drying step and immersion in water. This membrane had an average pore size of μ=24 nm, a standard deviation of σ=4 nm, and variability of σ/μ=0.16, comparable to other block copolymer membranes.

The inclusion of a rubbery poly(ethylene-alt-propylene) block in the middle of a glassy polystyrene block offered toughness to the SESO-122 kDa membrane. Notably, the work to fracture under uniaxial tension increased significantly from 2.6±1.5 KJ/m³ for SV to 200±50 KJ/m³ for SESO-122 kDa, even though the substructure macroporosity increased from 0 to 49%. Water permeation tests, conducted at transmembrane pressures up to 4.0 bar, showed a steady-state permeance for the SESO-122 kDa membrane of 670±89 L m⁻² h⁻¹ bar⁻¹ (LMH/bar), nearly double that of a track-etched polycarbonate membrane with twice the pore size, largely due to the much higher pore density and overall porosity.

These findings underscore the potential of block copolymers to manufacture mesoporous membranes that are not only permeable and selective but also highly ductile.

### Example 3: Isoporous SISV Tetrablock Polymer Membranes

This study created tough, isoporous membranes using a PS-PI-PS-P4VP (SISV) tetrablock polymer that exceed the superior mechanical properties of prior work. This polymer is substantially easier to fabricate into isoporous membranes compared to the tetrablock polymer that used poly(ethylene oxide) as the hydrophilic block. Optimization of the polymer concentration, dry step time, and additives facilitated the production of asymmetric, flat sheet membranes large enough for permeation and mechanical testing. Functionalization of the pore walls via quaternization of the P4VP block has been demonstrated in the literature and can also be achieved using this material (Qiu, X. et al. Selective Separation of Similarly Sized Proteins with Tunable Nanoporous Block Copolymer Membranes. ACS Nano 2013, 7 (1), 768-776; Zhang, Z. et al. Quaternization of a Polystyrene-Block-poly(4-vinylpyridine) Isoporous Membrane: An Approach to Tune the Pore Size and the Charge Density. Macromol. Rapid Commun. 2019, 40 (3), 1800729). These modifications can cause the pore walls to swell, shrinking the effective diameter of the pore and lowering the molecular weight cutoff of the membrane. These results indicate that the commonly used PS-P4VP polymer can be improved upon by toughening the matrix forming block by adding a rubbery domain in the middle of the two polystyrene domains, ultimately yielding a stand-alone polymer membrane capable of operating at higher transmembrane pressures than is typically seen in the PS-P4VP literature.

### Materials and Methods

Polymer Dope Casting Solution Preparation: To prepare casting solutions for SNIPS, target quantities of each solvent were mixed in a 20 mL scintillation vial that had been purged with dry nitrogen to remove any dust. To minimize evaporative losses, solvents were added in order of decreasing boiling point. The desired quantities of polymer were then weighed and added to the solvent mixture. Viscous solutions were left to rotate on a heated roller for at least two days prior to membrane fabrication to prepare visually homogenous casting solutions. Non-viscous solutions were mixed on a stir plate for at least two days before casting.

Asymmetric Membrane Preparation by Self-Assembly and Nonsolvent Induced Phase Separation (SNIPS): Each solution was poured onto a cleaned glass plate, after which a 4-inch Gardco doctor blade was used to meter the solution to a uniform thickness of 200 μm for all membranes. The cast solution was left in ambient air at ˜23° C. and 50-55% relative humidity (unless specified otherwise) for 5-60 s to undergo the evaporation step of the membrane formation process. After evaporation, the cast solution was immersed in a ˜23°° C. DI water bath to undergo wet phase inversion and complete the membrane formation process. The resulting membranes were left to soak in a beaker filled with DI water for 24 h to leach out residual solvent, then solvent exchanged for at least 2 h in a 50/50 (by volume) mixture of deionized water and methanol.

### Results and Discussion

Tetrablock Design Choice: The SISV polymer utilized in this work was synthesized via sequential anionic polymerization initiated from sec-butyllithium (see Example 1). The SIS architecture within the tetrablock that forms the structural matrix of the membrane has been previously shown to increase the mechanical toughness when compared to both diblock (i.e. PS-P4VP) and triblock (i.e., PI-PS-P4VP and PI-PS-PAA) architectures (Phillip et al., Id.). FIGS. 23A-23B detail the synthesis of the tetrablock. Optimization of the polymerization procedure was nontrivial. One issue was to determine the best way to rigorously dry the monomers and solvents used in the polymerization. Anionic polymerization was the desired polymerization method because it can be scaled reasonably easily to the batch sizes required for SNIPS. Extreme care must be given to remove as much water and impurities as possible from the monomers because the reactions are very sensitive to water. Optimizing the purification process involved optimizing the most suitable desiccants (i.e. calcium hydride, di-n-butylmagnesium, butylmagnesium chloride, ethylaluminum dichloride) for the correct amounts of time and for the correct sequences of freeze-pump-thawing and distilling. The other issue lies in the differences in reactivity and polarity of the monomers. Styrene and isoprene polymerize well in cyclohexane at 40° C.; however, 4-vinylpyridine is too reactive to polymerize in a controlled manner at these conditions and the resultant P4VP is not soluble in cyclohexane. The polymerization could theoretically be conducted in THF at low temperatures to avoid lithium carbanion ring-opening of the THF solvent; however, isoprene polymerizes very slowly at low temperature and the 3,4 isomer is favored at these temperatures whereas the 1,4 isomer is the desired isomer for the polymer. Other polar aprotic solvents such as anisole were investigated; however, these solvents were not suitable for the polymerization.

The final reaction conditions used for synthesizing the SISV tetrablock polymer are adapted from previous reports (FIGS. 23A-23B) (Phillip, et al. Id.; Dorin, R. M. et al. Designing Block Copolymer Architectures for Targeted Membrane Performance. Polymer 2014, 55 (1), 347-353). The PS-PI-PS portion of the synthesis was carried out in cyclohexane at 40° C., which is typical for anionic polymerizations of these monomers. After the first three blocks of the polymer had been synthesized, the living alkyl lithium end group was capped with a single unit of 1,1-diphenylethylene to decrease the reactivity of the living anion. Following this addition, the cyclohexane was carefully removed from the reactor via vacuum distillation, after which the nearly dry polymer was redissolved in rigorously dried THF. The reactor and a buret of 4-vinylpyridine in THF (15 wt % 4VP) were then cooled in a dry ice/isopropanol bath and with crushed dry ice, respectively. The polymerization of the final block was run at −78° C. for 3.5 hours to allow for the complete consumption of the 4-vinylpyridine, after which the reaction was terminated with degassed methanol and allowed to warm to room temperature. Over the course of the polymerization, the color of the reaction can be used to determine if the reaction is still alive and what monomers are currently at the reaction propagation center.

The choice of block sizes was based on both the studies by Philip et al. and previous work (Phillip, et al., Id.). Smaller pores are more easily achieved when the starting BCP is small, and therefore it is important to utilize the lowest molecular weight polymer that still forms a robust membrane. SNIPS membranes have been fabricated from polymers with hydrophilic blocks typically between 12-30% by weight (Rangou, S. et al. Self-Organized Isoporous Membranes with Tailored Pore Sizes. J. Membr. Sci. 2014, 451, 266-275). The relative block sizes can affect both solution ordering and final morphology, so it is important to study how a change in relative block size can affect the process. For these reasons, a variety of molecular weights and weight fractions of P4VP were synthesized.

Optimization of Casting Conditions: An additional method for producing isoporous membranes is through the addition of organic-soluble metal salts such as copper acetate, magnesium acetate, and aluminum acetate (Nunes, S. P. et al. Ultraporous Films with Uniform Nanochannels by Block Copolymer Micelles Assembly. Macromolecules 2010, 43 (19), 8079-8085). The P4VP block can coordinate tightly to these ions in solution via the nitrogen atom of the pyridine ring, which can bring these blocks together and help drive their segregation from the hydrophobic blocks in the casting solution. SEM's of the top surface are shown below in FIG. 24 and FIG. 25.

Understanding the Formation Mechanism through in situ GISAXS Study: FIGS. 26A-26B shows in situ GISAXS data.

Characterization of Membrane Performance: To quantify the relative toughness of these materials, tensile testing of dense films and asymmetric membranes of the tetrablock and the SV polymer was conducted (FIG. 27). For the dense films, the SISV and SV had similar maximum stresses; however, the SISV polymer had a larger strain energy density and was therefore more tough overall. The overall stresses the asymmetric membranes could tolerate was lower than for the dense films. The SV polymer was able to withstand the least stress and cracked after slight deformation. The SISV polymer was able to withstand significantly higher stress and exhibited more yielding, giving it significantly higher strain energy density. FIGS. 28A-28C show time rejection, permeance, and pore diameter.

### Conclusion

A SISV tetrablock polymer was synthesized and cast into mesoporous membranes with pore sizes in the ultrafiltration regime. Significant synthetic challenges existed for this polymer; however, many of the reaction conditions were carefully optimized to make the polymerization repeatable and easily scaled. A solvent swap midway through the reaction was the key step for polymerizing a final, significantly more polar block. Although further optimization is needed to achieve a perfectly isoporous surface, these asymmetric membranes have vastly superior mechanical strength compared to PS-P4VP diblock polymers as well as industrially used polysulfone membranes cast at similar polymer concentrations.

### Example 4: Supported Ionic Liquid Membranes (SILMs)

SILM Preparation: The polymer supports used were asymmetric, meaning that tortuosity and porosity vary with depth, so each SILM was prepared with the same film orientation (i.e., skin layer side up). IL was deposited on a support 0.5″ in diameter to completely cover the surface. For [hmim][Tf₂N] and [P₂₂₂₈][TMPP]SILMs, the ILs were allowed to soak into the supports for at least 24 h and 48 h, respectively, to ensure total wetting which was confirmed by IL pooling on the underside of the support. Excess IL was removed from the surface of the SILMs by patting dry with a Kimwipe. Using epoxy, the edge of the SILM was attached to the inner edge of a brass disc with a hole 0.375″ in diameter bored in the center such that the disc could be mounted inside a Millipore filter cell for gas permeation testing. Here, the skin layer of the support was oriented towards the feed side. The active area of the membrane was determined by scanning the resulting brass disc with the attached SILM using a CanoScan LiDE 400 scanner from Canon.

Pure-Gas Permeation Measurements: Gas transport through SILMs is reported in terms of permeance—rather than permeability—due to inherent uncertainty regarding the effective thickness of the trapped IL. The pure-gas permeances of carbon dioxide, propane, ethane, methane, and nitrogen were measured with three independent measurements for each IL using the constant-volume variable-pressure method. The permeation system used was custom designed in-house and is described elsewhere (Elimelech, et al., Id.). All permeation experiments were conducted at 35° C., and SILM samples were degassed under technical vacuum for at least 12 h prior to each run. Then, one of the desired gases was introduced to the upstream side of the system and allowed to permeate through the membrane into an isolated volume initially under vacuum. After steady-state was achieved, the permeance (or pressure-normalized flux), P [cm³ (STP)·(cm²·s·cm Hg)⁻¹], was calculated as follows (Zydney, A. L. Membrane Technology for Purification of Therapeutic Proteins. Biotechnol. Bioeng. 2009, 103 (2), 227-230):

$$P = \frac{{V}_{d}}{{p}_{2} ART} [ {( \frac{{dp}_{1}}{dt} )}_{ss} - {( \frac{{dp}_{1}}{dt} )}_{leak} ] \qquad ( EQ . 20 )$$

where V_{d} is the downstream volume (cm³), p₂ is the upstream absolute pressure (cm Hg), A is the film area available for gas transport (cm²), R is the gas constant [0.278 cm Hg·cm³·(cm³ (STP)·K)⁻¹], T is absolute temperature (K), (dp₁/dt)ₛₛ is the steady-state rate of pressure rise (cm Hg·s⁻¹) in the downstream volume at fixed upstream pressure, and (dp₁/dt)ₗₑₐₖ is the steady-state rate of pressure rise (cm Hg·s⁻¹) in the downstream volume when isolated. Here, permeance is reported in units of GPU, with 1 GPU=10⁻⁶ cm³ (STP)· (cm²·s·cm Hg)⁻¹.

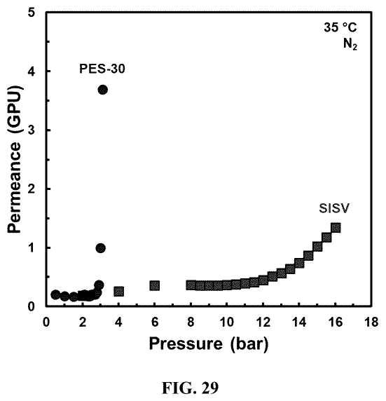

Determination of the Blowout Pressure: Blowout is characterized by a sudden increase in gas permeance by several orders of magnitude and loss of selectivity caused by the expulsion of IL from the pores of the support membrane. The blowout pressure of SILMs was determined using a constant-volume variable-pressure permeation system. Samples were prepared using the previously described procedure and subjected to N₂ permeation tests. The pressure on the upstream side of the membrane was gradually increased in increments of 0.1-0.5 bar, depending on the sample, and each pressure step was held for at least 30 minutes to ensure SILM stability. This process was continued until the SILM experienced blowout. In this study, the blowout pressure was taken as the first pressure step where the N₂ permeance was observed to be more than three standard deviations greater than the average initial N₂ permeance of the SILMs. These tests were carried out 5 times for each sample, and variance is assumed to be normally distributed. The blowout pressure is dictated by the size of the largest pore on the membrane surface. Therefore, using an isoporous support is extremely beneficial for being able to operate these membranes at higher transmembrane pressures. A blowout experiment is shown in FIG. 29 comparing using a commercial polyethersulfone (PES-30) membrane and an isoporous SISV membrane as the support for the IL.

What is claimed is:

1. A tetrablock polymer, comprising: the formula ABAC, wherein A, B and C are each blocks of the polymer, where A is glassy block; B is a rubbery block; and C is a hydrophilic block.

2. The polymer of claim 1, wherein block A is polystyrene or polyvinycyclohexane.

3. The polymer of claim 1, wherein block B is polyisoprene, polybutadiene, polyethylene, polypropylene, or polyethylene alt-propylene.

4. The polymer of claim 1, wherein block C is poly-4-vinylpyridine or polyethylene oxide.

5. The polymer of claim 1, wherein block C comprises a quaternized ammonium ion, pyridinium, piperazinium, another suitable nucleophile, or any combination thereof.

6. The polymer of claim 1, wherein block A is from about 25 wt. % to about 80 wt. % of the polymer.

7. The polymer of claim 1, wherein block B is from about 5 wt. % to about 40 wt. % of the polymer.

8. The polymer of claim 1, wherein block Cis from about 10 wt. % to about 30 wt. % of the polymer.

9. The polymer of claim 1, wherein block A and block B are present in the polymer at a ratio of from about 2:1 to about 6:1.

10. The polymer of claim 1, wherein the polymer has a molecular weight of from about 50 kDa to about 250 kDa.

11. The polymer of claim 1, wherein the polymer is a poly(styrene-b-isoprene-b-styrene-4-vinylpyridine) or poly(styrene-b-(ethylene-alt-propylene)-b-styrene-b-ethylene oxide).

12. A membrane, comprising: the polymer of claim 1 organized to define pores with an average pore diameter of about 15 nm to about 50 nm.

13. A supported ionic liquid membrane, comprising: the membrane of claim 12 and an ionic liquid within the pores.

14. A method of forming a membrane, comprising:
casting a solution comprising the polymer of claim 1, a solvent for the polymer, and a salt onto a substrate;
drying the cast solution; and
contacting the dried, cast solution with a nonsolvent.

15. The method of claim 14, wherein the solvent comprises one or more of dioxane, tetrahydrofuran, dimethylformamide, dimethylacetamide (DMAc), N-methyl-2-pyrrolidone (NMP), acetone, and sulfolane.

16. The method of claim 14, wherein the salt is copper bistriflimide or copper bis(pentafluoroethylsulfonyl) imide.

17. The method of claim 14, wherein the salt is Cu^{II}(acetate)₂, Mg^{II}(acetate)₂, Fe^{II}(acetate)₂, Co^{II} (acetate)₂, Ni^{II} (acetate)₂, Cu^{II} (BF₄)₂, or Cu^{II}(Cl)₂.

18. The method of claim 14, wherein the drying step is from about 1 second to about 75 seconds.

19. A method of purifying a liquid or gas, comprising: contacting the membrane of claim 12 with the liquid or gas.
